(19) United States
(12) Patent Application Publication
(10) Pub. No.: US 2006/0267243 A1
(43) Pub. Date: Nov. 30, 2006

(54) Method for compounding polymer pellets with functional additives

(76) Inventor: Debra Tindall, Kingsport, TN (US)

Correspondence Address: Louis N. Moreno;Eastman Chemical Company, P.O. Box 511, Kingsport, TN, 37662-5075, US

(21) Appl. No.: 11/439,041

(22) Filed: May 23, 2006

Related U.S. Application Data
(60) Provisional application No. 60/684,739, filed on May 26, 2005.
(60) Provisional application No. 60/684,741, filed on May 26, 2005.

(51) Int. Cl. B29C 47/00

(52) U.S. Cl. 264/211.11; 264/328.1; 264/343

(57) ABSTRACT

New methods of forming compounded cellulose esters are provided. The methods comprise mixing a cellulose ester, functional additive, and a swelling agent and subsequently removing at least a portion of the swelling agent. The swelling agent is one that assists in causing the functional additive to penetrate into the cellulose ester, while not acting significantly as a solvent for the cellulose ester. Preferred cellulose esters include, but are not limited to, cellulose acetates, cellulose triacetates, cellulose acetate phthalates, and cellulose acetate butyrates. The functional additive can be a plasticizer, stabilizer, or other additive selected to modify a particular property of the cellulose.

### RELATED APPLICATIONS

This application claims the priority benefit of provisional application entitled, METHOD FOR COMPOUNDING CELLULOSE ESTERS, Ser. No. 60/684,739, filed May 26, 2005, incorporated by reference herein, and of provisional application entitled, PROCESS FOR COMPOUNDING POLYMER PELLETS WITH FUNCTIONAL ADDITIVES, Ser. No. 60/684,741, filed May 26, 2005, incorporated by reference herein.

### BACKGROUND OF THE INVENTION

1. Field of the Invention

The present invention is broadly concerned with novel methods of forming admixtures of cellulose and functional additives that can be used to form articles such as films, fibers, and time-release matrices.

2. Description of the Prior Art

Cellulose has been esterified with various aliphatic and aromatic carboxylic acids. The most typical cellulose esters are cellulose acetates, propionates, butyrates, and mixed esters, such as cellulose acetate propionate and cellulose acetate butyrate. Cellulose esters and the manufacture thereof are reviewed by Gedon et al., “Cellulose Esters,” Kirk-Othmer Encyclopedia of Chemical Technology, 4th ed., vol. 5, John Wiley & Sons, New York, 496-529 (1993), incorporated by reference herein. Cellulose ester manufacture is also described in Steinmeier, Macromolecular Symposia (2004), 208 (Cellulose Acetates), 49-60, incorporated by reference herein. U.S. Pat. Nos. 2,196,768 and 3,022,287, each incorporated by reference herein, also describe procedures for manufacturing cellulose esters.

A variety of cellulose esters are commercially available. For example, one commercial supplier of cellulose esters is Eastman Chemical Company, Inc., Kingsport, Tenn. Typical cellulose esters that are commercially available include cellulose acetate, cellulose propionate, cellulose butyrate, cellulose acetate propionate, cellulose acetae butyrate, cellulose propionate butyrate, carboxymethyl cellulose acetate propionate, and carboxymethyl cellulose acetate butyrate.

Cellulose esters are typically produced in the form of powders, pellets, grains, spheres, elongated spheres, or granular shapes. Of these forms, the pellets, grains, spheres, elongated spheres, and granular shapes are desirable because of the ease of washing, handling, and conveying, and because of the low dust content.

Cellulose esters are known to be excellent thermoplastic materials and, accordingly, cellulose esters are utilized in a broad range of applications. Some applications utilizing cellulose esters are described by Edgar et al., “Advances in Cellulose Ester Performance and Application” Progress in Polymer Science 26(9), 1605-1688 (2001), incorporated by reference herein. The cellulose esters most commonly used for their good thermoplastic properties are cellulose acetate (CA), cellulose acetate propionate (CAP), and cellulose acetate butyrate (CAB). However, other types of cellulose esters can be useful for certain applications.

Each of these materials has relatively high melting or softening temperatures (i.e., 150-250EC) and relatively high melt viscosities. Because of this combination of high melting temperature and high melt viscosity, the temperatures needed to melt process these cellulose esters may, in some cases, approach or exceed the decomposition temperature of the cellulose ester. As a result, cellulose esters can degrade during processing, which can minimize their usefulness in certain applications. In order to lower the melt processing temperature, low molecular weight plasticizers may be added prior to, or during, the melt processing of the cellulose esters.

The compatibility and infusion of functional additives such as plasticizers can vary greatly depending on the composition and form of the cellulose ester. For example, dioctyl adipate generally exhibits poor compatibility with cellulose acetates, but good compatibility with most cellulose acetate butyrates. The compatibility of the plasticizer also can change with the degree of substitution (the number of substituents per anhydroglucose unit), even within a single type of cellulose ester. For example, diethyl phthalate (“DEP”) may be used as a plasticizer for cellulose acetate with a degree of substitution of 2.5 or below; however, DEP is considered to be a poor plasticizer for cellulose acetate with a degree of substitution of from 2.8 to 3.0.

Functional additives are often mixed with cellulose esters by conventional melt compounding techniques which involve combining the cellulose ester with plasticizer and other additives in a twin screw extruder with appropriate mixing elements and at appropriate temperatures and pressures to achieve a molten, homogeneously combined, cellulose ester mixture by the time the materials exit the extruder. It is typically desirable to extrude the molten, compounded, cellulose ester mixture through a die with orifices that are about 2-6 mm in diameter so as to extrude a strand. This strand is then cooled by water or air and cut at regular intervals to provide a uniform and desirable size and shape, referred to as “pellets” or “granules.”

Mixing or infusing a functional additive completely into a cellulose ester can be difficult, especially if the cellulose ester or the functional additive is thermally unstable at typical compounding temperatures. For example, cellulose triacetate and other cellulose esters are sometimes manufactured in the form of a pellet. This pellet is quite hard and in its natural state does not readily absorb plasticizer or additives. Under conventional, standard melt extrusion conditions (260-270EC barrel temperature, generic twin screw design), the molten strand exiting the extruder has noticeable unmelted areas due to inadequate penetration and nonuniform mixing of the plasticizer with the whole of the pellet. Increasing the temperature helps make the melting more complete, but at the expense of increasing color with increasing temperature because thermal degradation of pure cellulose triacetate occurs at 350-360EC. Furthermore, some additives may be thermally sensitive and unable to withstand the required two heat histories, i.e., melt compounding the material, followed by melt processing to form the final plastic article. The pellet itself also may be the desired final shape such as, for example, in a controlled release matrix product. In this case, it might be desirable that the components not be exposed to excessive heat. Certain plasticizers and other additives can lower the onset of degradation to below 300EC, and their addition can produce additional color. Lower temperatures help reduce color, but the high softening point of some cellulose esters requires increasing the temperature.

In addition, melt compounding or melt processing of cellulose triacetate in plastics applications is not commercially viable because it is not practical to melt process cellulose triacetate due to its high melting point relative to its decomposition temperature, and due to its limited softening upon addition of plasticizers. Commercial cellulose triacetate films are currently produced by solvent casting.

Thermally sensitive additives may be integrated into a cellulose ester by solvent compounding. However, solvent melt compounding a functional additive into a cellulose ester also has the disadvantage that the form of the cellulose ester is destroyed, and the compounded product has to be reprecipitated or extruded a second time to obtain a convenient form (e.g., pellet). It would be advantageous to make further use of this pellet or granular precipitated cellulose ester and maintain this desirable form while compounding the cellulose ester with a functional additive. Thus, if the material is already in this desirable shape, the “compounding” step would only need to accomplish incorporation of the functional additives into those pellets.

There is a need for a method of introducing plasticizers and other additives into cellulose esters, particularly cellulose triacetate, that would provide a compounded cellulose without the use of heat, and without changing the general form of the cellulose ester pellet.

### SUMMARY OF THE INVENTION

The present invention overcomes these problems by broadly providing new methods of forming compounded cellulose by combining a cellulose, an additive, and a swelling agent to form an admixture.

In one embodiment, the present invention provides a method for infusing a cellulose pellet, grain, or granule with at least one additive. The method comprises forming an admixture by combining a cellulose ester, an initial quantity of an additive, and a swelling agent, and then removing at least a portion of the swelling agent from the admixture so as to form the compounded cellulose ester. Advantageously, the compounded cellulose ester comprises at least about 0.01% or 0.1% or 1% or 5% or 10% or 20% or 30% or 40% or 50% or 60% or 70% or 80% or 90% by weight of the initial quantity of the additive.

In another embodiment, the invention provides a method wherein a cellulose ester, an initial quantity of an additive, and a swelling agent are combined to yield an admixture and removing at least a portion of the swelling agent from the admixture so as to form the compounded cellulose ester. In this embodiment, the swelling agent comprises less than about 10% by weight of ingredients selected from the group consisting of water, benzene, sulfonated castor oil, xylene, toluene, monopol oil, pine oil, sulfonated pine oil, cyclohexanol, cyclohexanone, diacetin, and tetralin.

### BRIEF DESCRIPTION OF THE DRAWINGS

FIG. 1 is a series of photographs comparing a control sample to an inventive sample over the course of 27 hours.

### DETAILED DESCRIPTION OF THE PREFERRED EMBODIMENTS

The present invention provides new methods of forming compounded cellulose ester by combining a cellulose ester, an additive, and a swelling agent to form an admixture. Combining the ingredients can be accomplished by any known mixing technique, including, but not limited to, rolling in a cylindrical container, overhead stirring, sigma blade mixing, and tumbling.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C₁ to C₅ hydrocarbons”, is intended to specifically include and disclose C₁ and C₅ hydrocarbons as well as C₂, C₃, and C₄ hydrocarbons.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

As used herein, the articles “a,” “an,” and “the” include their plural referents unless the context clearly dictates otherwise. For example, reference to a “polymer,” or a “shaped article,” is intended to include the processing or making of a plurality of polymers, or articles. References to a composition containing or including “an” ingredient or “a” polymer is intended to include other ingredients or other polymers, respectively, in addition to the one named.

By “comprising” or “containing” or “including,” it is meant that at least the named compound, element, particle, or method step, etc., is present in the composition or article or method, but does not exclude the presence of other compounds, catalysts, materials, particles, method steps, etc., even if the other such compounds, material, particles, method steps, etc., have the same function as what is named, unless expressly excluded.

It is also to be understood that the mention of one or more method steps does not preclude the presence of additional method steps before or after the combined recited steps or intervening method steps between those steps expressly identified. Moreover, the lettering of process steps or ingredients is a convenient means for identifying discrete activities or ingredients and the recited lettering can be arranged in any sequence, unless otherwise indicated.

The cellulose ester can be in any physical shape (e.g., pellets, powders, granules, fibers) and, in one embodiment, can include other functional groups such as ether groups. Preferred cellulose esters have a degree of substitution (i.e., the number of substituents per anhydroglucose unit) of from about 0.7 to about 3.0. In one embodiment, the degree of substitution is preferably from about 2.7 to about 3.0, and more preferably from about 2.8 to about 2.95. In another embodiment, the degree of substitution is preferably from about 0.7 to about 2.0, and more preferably from about 1.5 to about 1.9. Furthermore, preferred cellulose esters will have a weight average molecular weight (measured as described below) of from about 5,000 to about 400,000 Daltons, more preferably from about 100,000 to about 300,000 Daltons, and even more preferably from about 125,000 to about 250,000 Daltons.

Preferred cellulose esters comprise C₁-C₂₀ esters of cellulose, more preferably C₂-C₂₀ esters of cellulose, and even more preferably C₂-C₁₀ esters of cellulose and yet more preferably C₂ to C₄ esters of cellulose. Secondary and tertiary cellulose esters are also preferred. Particularly preferred cellulose esters for use in the present invention are selected from the group consisting of cellulose acetate, cellulose triacetate, cellulose acetate phthalate, cellulose acetate butyrate, cellulose butyrate, cellulose tributyrate, cellulose propionate, cellulose tripropionate, cellulose acetate propionate, carboxymethylcellulose acetate, carboxymethylcellulose acetate propionate, carboxymethylcellulose acetate butyrate, cellulose acetate butyrate succinate, and mixtures thereof.

In one embodiment, the cellulose ester has a degree of substitution of from about 1.0 to about 3.0. In another embodiment, the cellulose ester is cellulose acetate with a degree of substitution of from about 2.5 to about 3.0, and preferably from about 2.7 to about 3.0. In another embodiment, the cellulose ester is cellulose acetate with a degree of substitution of acetyl of from about 0.5 to about 2.0, and preferably from about 1.6 to about 1.8. In another embodiment, the cellulose ester is a cellulose acetate propionate with degree of substitution of acetyl of from about 0.1 to about 2.1, and a degree of substitution of propionyl of from about 0.5 to about 2.5. In another embodiment, the cellulose ester is a cellulose acetate butyrate with degree of substitution of acetyl of from about 0.3 to about 2.1, and a degree of substitution of butyryl of from about 0.75 to about 2.6.

The cellulose ester is preferably utilized at sufficient levels that the admixture comprises from about 5% to about 95% by weight cellulose ester, preferably from about 50% to about 90% by weight cellulose ester, and even more preferably from about 70% to about 85% by weight cellulose ester, based upon the combined weight of the cellulose ester(s) and additive(s) taken as 100% by weight.

Swelling agents, as used herein, are compounds that swell, or “open up,” the cellulose ester, but without dissolving that cellulose ester. That is, the cellulose ester typically will be less than about 5%, preferably less than about 2%, and more preferably less than about 1% soluble in the swelling agent over a period of about 120 minutes at a concentration of 50% by weight cellulose ester. Furthermore, the swelling agent will sufficiently swell the cellulose ester such that at least about 0.01% or, 0.1% or, 0.5% or, 1% or, 2% or, 3% or, 4% or, 5% or, 10% or, 20% or, 30% or, 40% or, 50% or, 60% or, 70% or, 80% or, 90% or, 92% or, 93% or, 94% or, 95% or, 96% or, 97% or, 98% by weight, preferably at least about 99% by weight, and more preferably about 100% by weight of the initial quantity of the additive will be intermixed with the cellulose ester and remain in the final compounded cellulose ester.

Preferred swelling agents include, but are not limited to, those selected from the group consisting of ketones, (e.g., acetone, methyl ethyl ketone), esters (e.g., ethyl acetate, methyl acetate), alcohols (e.g., methanol, ethanol, isopropyl), ethers, carboxylic acids (e.g., acetic acid), tetrahydrofuran, supercritical fluids (e.g., supercritical carbon dioxide), and mixtures thereof. In a preferred embodiment, the swelling agent comprises less than about 10% by weight, preferably less than about 5% by weight, and preferably about 0% by weight of ingredients selected from the group consisting of water, benzene, sulfonated castor oil (also referred to as “Turkey red oil”), xylene, toluene, monopol oil, pine oil, sulfonated pine oil, cyclohexanol, cyclohexanone, diacetin, and tetralin. Should the swelling agent include a mixture of one or more of water, benzene, sulfonated castor oil (also referred to as “Turkey red oil”), xylene, toluene, monopol oil, pine oil, sulfonated pine oil, cyclohexanol, cyclohexanone, diacetin, and/or tetralin, the combined weight of each of these ingredients will be less than about 10% by weight, preferably less than about 5% by weight, and preferably about 0% by weight of the total swelling agent present.

The amount of swelling agent utilized in the inventive methods should be in an amount sufficient to adequately penetrate and swell the cellulose matrix, and thus adequately disperse the additive throughout the cellulose matrix. It is also preferable that the amount of swelling agent utilized be in an amount sufficiently low that after a period of contact time with the swelling agent and additive, the swelled cellulose will be dry-to-the-touch and free flowing particles rather than a slurry. This would typically result in a weight ratio of swelling agent:cellulose ester of from about 0.8:1 to about 3:1, and more preferably from about 1:1 to about 1.5:1.

The additive(s) used with the inventive methods is preferably a functional additive. It is preferred that the additive modify or protect some property of the cellulose ester. Preferred additives include those selected from the group consisting of plasticizers, thermal stabilizers, antioxidants, ultraviolet (UV) stabilizers, acid stabilizers, acid scavengers, dyes, pigments, fragrances (including odor masks), optical brighteners, flame retardants, agricultural chemicals (e.g., pesticides, herbicides, fertilizers, insecticides, trace minerals), bioactive compounds (e.g., pharmaceuticals, medicaments, nutraceuticals), indicators, and mixtures thereof.

Plasticizers are described in “Handbook of Plasticizers,” Ed. Wypych, George, ChemTec Publishing (2004), incorporated by reference herein. In one embodiment, preferred plasticizers facilitate processing, increase flexibility, and/or increase toughness of a product containing a polymer by replacing some of the secondary valence bonds of the polymer with plasticizer-to-polymer bonds. Examples of plasticizers suitable for use as additives in the present invention include, but are not limited to, those selected from the group consisting of dimethyl phthalate, diethyl phthalate, dibutyl phthalate, dioctyl phthalate, diisononyl phthalate, butyl benzyl phthalate, butyl phthalyl butyl glycolate, tris(2-ethyl hexyl)trimellitate, triethyl phosphate, triphenyl phosphate, tricresyl phosphate, p-phenylene bis(diphenyl phosphate), and other phosphate derivatives, diisobutyl adipate, bis(2-ethyl hexyl)adipate, triethyl citrate, acetyl triethyl citrate, plasticizers comprising citric acid (e.g., Citroflex™ plasticizers, available from Morflex), triacetin, tripropionin, tributyrin, sucrose acetate isobutyrate, glucose penta propionate, triethylene glycol-2-ethylhexanoate, polyethylene glycol, polypropylene glycol, polypropylene glycol dibenzoate, polyethylene glutarate, polyethylene succinate, polyalkyl glycoside, 2,2,4-trimethyl-1,3-pentanediol isobutyrate, diisobutyrate, phthalic acid copolymers, 1,3-butanediol, 1,4-butanediol end-capped by aliphatic epoxide, bis(2-ethyl hexyl)adipate, epoxidized soybean oil, and mixtures thereof.

Examples of UV absorbers and UV stabilizers suitable for use as additives in the present invention include, but are not limited to, those selected from the group consisting of benzotriazoles, triazines, hydroxybenzophenone, benzoxazinone, resorcinol monobenzoates, salicylic esters (e.g., 2,6-dialkylphenyl salicylate), p-octylphenyl salicylate, cinnamic derivatives, oxanilides, hydroxybenzoic esters, sterically hindered triazines, sterically hindered amine light scavengers (HALS), compounds in the Tinuvin®, Chimassorb®, Cyasorb® (available from Ciba) and Univul™ (available from BASF) product series, and mixtures thereof. UV absorbers and stabilizers are typically present at about 0.01 to about 5% by weight, based upon the weight of the cellulose ester taken as 100% by weight.

Thermal stabilizers may be necessary if secondary melt forming is desired. Examples of thermal stabilizers suitable for use as additives in the present invention include, but are not limited to, those selected from the group consisting of antioxidants, radical scavengers, radical terminators, metal scavengers, peroxide decomposers, and metal salts. More specifically, thermal stabilizers may include compounds selected from the group of hindered phenols, hindered amines, epoxides of natural oils, organic phosphites, and mixtures thereof. Some preferred thermal stabilizers include those sold under the names Irganox®, Irgafos®, and Irgastab® (available from Ciba). Antioxidants may include organic phosphites, with trialkyl (C₁-C₁₀, more preferably C₁-C₄), alkyl (C₁-C₁₀, more preferably C₁-C₄)phenyl, and/or triphenyl phosphites being particularly useful.

Examples of suitable stabilizing metal agents include, but are not limited to, those selected from the group of alkali and alkaline metal salts, including salts of lithium, sodium, potassium, rubidium, cesium, beryllium, magnesium, calcium, strontium, and barium. Suitable inorganic and organic acid salts of alkali and alkaline metals include, but are not limited to, the hydroxides, carbonates, hydrogen carbonates, citrates, lactates, tartrates, maltates, oxylates, phosphates, acetates, propionates, etc., and mixtures thereof. Thermal stabilizers are typically present at levels of from about 0.05% to about 5% by weight, and preferably from about 0.1% to about 2% by weight, based upon the total weight of the cellulose ester taken as 100% by weight.

Dyes may be used to provide a desired toning or visual effect. Examples of suitable organic dyes include, but are not limited to, those selected from the group consisting of C. I. Solvent Violet 13, C. I. Pigment Blue 15, C. I. Pigment Blue 28, C. I. Dispersion Violet 8, C. I. Pigment Red 122, and mixtures thereof. Examples of fluorescent dyes or optical brightener dyes include those selected from the group consisting of Eccowhite and Eccobright products (available from Eastern Color & Chemical Company), Eastobrite OB-1 (available from Eastman Chemical Company), fluorescein, and mixtures thereof. Examples of specialty or novelty dyes include thermochromic and photochromic dyes. The inventive method is particularly advantageous because dyes and colorants that cannot withstand the standard melt compounding process due to volatility or thermal degradation could be utilized in the present invention.

Examples of suitable fragrances, repellant scents, odor neutralizers, and odor masks include, but are not limited to, those disclosed in Fabulous Fragrances, by Jan Moran; Fragrances of the World, by Michael Edwards; The Illustrated Encyclopedia of Essential Oils, by Julia Lawless; Chemistry of Fragrant Substances, by Paul Jose Teisseire; The Fragrance Foundation Reference Guide 1999, The Fragrances Foundation (New York, 1999), each incorporated by reference herein. Specific fragrances may be selected from the group consisting of pennyroyal, vanillin, esters, linalool, citronellal, certain aldehydes and esters, complex perfume mixtures, plant extracts, and mixtures thereof. The inventive method is particularly advantageous because fragrances that cannot withstand the standard melt compounding process due to volatility or thermal degradation could be utilized in the present invention.

Examples of suitable indicators for use in the present invention include, but are not limited to, those selected from the group consisting of pH indicators, moisture indicators, redox indicators, and temperature indicators. Examples of suitable pH indicators include those selected from the group consisting of phenolphthalein, litmus, thymol blue, tropeolin OO, methyl yellow, methyl orange, bromophenol blue, bromocresol green, methyl red, bromothymol blue, phenol red, neutral red, thymolphthalein, alizarin yellow, tropeolin O, nitramine, and trinitrobenzoic acid. An example of a moisture indicator is cobalt chloride. Examples of temperature indicators include thermochromic dyes, such as indoine blue, spiropyran derivatives. Examples of suitable redox indicators include those selected from the group consisting of ferroin, iodine/starch, bis(4-dialkylaminophenyl)squaraine dyes, KMnO₄, and K₂Cr₂O₇.

Examples of insecticides include those selected from the group consisting of organochlorine compounds, organophosphate compounds, aryl compounds, heterocyclic compounds, organosulfur compounds, carbamate compounds, formamidine compounds, dinitrophenol compounds, organotin compounds, pyrethroid compounds, acylurea compounds, botanical compounds, antibiotic compounds, fumigant compounds, repellant compounds, inorganic compounds, and mixtures thereof.

Examples of herbicides include those selected from the group consisting of ALSase inhibitors, aromatic carboxylic acids, chloroacetamides, triazines, ESPSase inhibitors, ACCase inhibitors, dinitroaniline compounds, bentazons, halohydroxybenzonitriles, diphenyl ethers, isoxazolidones, paraquats, and mixtures thereof.

The additive is preferably utilized at sufficient levels that the admixture comprises from about 5% to about 95% by weight additive, preferably from about 10% to about 50% by weight additive, and even more preferably from about 15% to about 30% by weight additive, based upon the combined weight of the cellulose ester(s) and additive(s) taken as 100% by weight.

After combining the cellulose ester, additive, and swelling agent to form an admixture, it is preferred that the swelling agent is then removed so as to yield an admixture of the cellulose ester and additive. The swelling agent can be removed by a number of methods, including by evaporation. Even more preferably, the swelling agent removal step is accompanied by a swelling agent recovery system so that the swelling agent can be reused. Preferably, this removal step results in at least about 10%, or 20%, or 30% or 40%, or 50%, or 60%, or 70%, or 80% or 90%, or 95% by weight, preferably at least about 98% by weight, and more preferably about 100% by weight of the swelling agent being removed from the admixture.

It will be appreciated that the resulting compounded cellulose ester has one or more desirable properties when compared to compounded cellulose ester prepared by prior art melt compounding. For example, because the inventive methods accomplish compounding without the need for high temperatures, the inventive compounded cellulose ester does not suffer from thermal degradation. As a result, the weight average molecular weight of the cellulose ester in the final compounded cellulose ester will be at least about 98%, preferably at least about 99%, and even more preferably at least about 100% of the weight average molecular weight of the starting cellulose ester.

Furthermore, avoiding the high temperatures of prior art melt compounding processes also avoids thermal discoloration of the compounded cellulose ester that was problematic in these prior art processes. Thus, in a preferred embodiment, the inventive compounded cellulose esters can be formed into films having a percent transmittance of at least about 85%, preferably at least about 88%, more preferably at least about 91%, and even more preferably at least about 95%, at a thickness of about 5 mils and at light having a wavelength of about 400 nm.

The inventive compounded cellulose ester will have substantially the same physical shape (e.g., pellets, powders, granules, fibers) as the starting cellulose ester material. The compounded cellulose ester can be used “as is,” or it can be subjected to the necessary secondary processing steps (e.g., melt processing such as extrusion or injection molding) to form the desired shaped article or product. For example, the compounded cellulose ester can be formed into a film such as those used in LCD applications. Advantageously, the weight average molecular weight of the cellulose ester in the shaped article or product will be at least about 73%, preferably at least about 77%, and even more preferably at least about 80% of the weight average molecular weight of the starting cellulose ester.

Potential processing steps are described in detail below.

### Preparation of a Shaped Article

The compounded cellulose ester can be used as a feedstock to be heated and melt-processed. In one embodiment, the compounded cellulose ester is shaped by a melt extrusion process such as profile extrusion, sheet extrusion, film extrusion, film casting, extrusion blow molding, and pultrusion. Melt processing techniques are described by Vlachopoulos, J. et al., Materials Science and Technology, 19(9), pgs. 1161-1169 (2003), incorporated by reference herein. Extrusion methods are described in Screw Extrusion: Science and Technology (Progress in Polymer Processing), Eds. White et al., Hanser Gardner Publications (2003), incorporated by reference herein.

In another embodiment, the compounded cellulose ester is shaped by a melt injection molding process. Injection molding is used for the production of numerous parts, small and large, by injecting the molten polymer into mold cavities. Examples of melt injection molding include injection molding, injection blow molding, injection stretch blow molding, injection transfer molding, injection overmolding, and insert molding. The process details of injection molding are discussed in Injection Molding Handbook (3rd Ed.) Eds. Rosato et al., Springer (2000), and Injection Molding: An Introduction, Potsch et al., Hanser Gardner Publications (1995), each incorporated by reference herein.

### Preparation of a Controlled Release Matrix System

In another embodiment, the compounded cellulose ester can be used to form a controlled release matrix system, such as one that could effect the controlled release of, for example, a fragrance, agricultural additive, or pharmaceutical additive. The additive is not simply loaded or incorporated into the exterior surface pores of the matrix system. Rather, the controlled release matrix system is a substantially homogeneous mixture of the cellulose ester and the additive. This slow release matrix system may comprise a residual swelling agent at levels of from about 0.005% to about 5% by weight of the matrix system.

The controlled release matrix system of the present invention permits the release of the additive at various rates depending upon the selection and the amount of the cellulose ester and the additive, and the molecular weight and degree of substitution of the cellulose ester. Preferably, in one embodiment a plasticizer is also used to control the diffusion rate.

Importantly, in the present invention the additive is not chemically attached to the cellulose ester. Thus, unlike some prior art controlled release systems, hydrolysis of the chemical bond between the additive and the polymeric support material is not required in order to release the additive. In certain embodiments the cellulose ester may be biodegradable, such that the additive is released by biodegradation of the cellulose ester. Or, the cellulose ester may be nonbiodegradable so that the additive is released by diffusion.

In one controlled release matrix embodiment, the cellulose ester has a degree of substitution of from about 1.0 to about 3.0. In another embodiment, the cellulose ester is cellulose acetate with a degree of substitution of from about 2.5 to about 3.0, and preferably from about 2.7 to about 3.0. In another embodiment, the cellulose ester is cellulose acetate with a degree of substitution of acetyl of from about 0.5 to about 2.0, and preferably from about 1.6 to about 1.8. In yet another controlled release matrix embodiment, the cellulose ester is a cellulose acetate propionate with degree of substitution of acetyl of from about 0.1 to about 2.1, and degree of substitution of propionyl of from about 0.5 to about 2.5. In yet another embodiment, the cellulose ester is a cellulose acetate butyrate with degree of substitution of acetyl of from about 0.3 to about 2.1, and degree of substitution of butyryl of from about 0.75 to about 2.6. It is preferred, in one embodiment, that the controlled release matrix comprise from about 50% to about 99.9% by weight cellulose ester, and preferably from about 70% to about 99% by weight cellulose ester, based upon the total weight of the matrix system taken as 100% by weight.

A wide variety of fragrances can be used in the controlled release matrix aspect of the invention. Any fragrance or fragrance blend that is diffusible into the swelled cellulose ester matrix may be incorporated. Fragrances useful in the present invention include those disclosed in Fabulous Fragrances, by Jan Moran; Fragrances of the World, by Michael Edwards; The Illustrated Encyclopedia of Essential Oils, by Julia Lawless; Chemistry of Fragrant Substances, by Paul Jose Teisseire; The Fragrance Foundation Reference Guide 1999, The Fragrances Foundation (New York, 1999), each incorporated by reference herein. The perfume may comprise a complex blend of fragrance compounds, or extracts can be incorporated into the controlled release matrix system. Alternatively, the fragrance additive can be an odor mask. A plasticizer can be incorporated with the fragrance to modify the controlled release diffusion rate.

A wide variety of pharmaceutical or bioactive additives can be used in the controlled release matrix system. Any pharmaceutical additive that is compatible with the biodegradable cellulose ester can be used in the present invention. Pharmaceutical additives useful in the present invention are disclosed in the Physician's Desk Reference.

Depending upon the intended mode of administration, controlled release matrix systems comprising a pharmaceutical additive can be in pharmaceutical compositions in the form of solid or semi-solid dosage forms such as tablets, suppositories, pills, capsules, powders, liquids, suspensions, lotions, creams, gels, or the like, preferably in unit dosage forms suitable for single administration of a precise dosage. In addition, the controlled release matrix system may include other medicinal agents, pharmaceutical agents, carriers, adjuvants, diluents, etc.

For oral administration, fine powders or granules may contain diluting, dispersing, and/or surface active agents, and may be presented in water or in a syrup; in capsules or sachets in the dry state; in a nonaqueous solution or suspension; in tablets, or in a suspension in water or a syrup. Where desirable or necessary, flavoring, preserving, suspending, thickening, and/or emulsifying agents may be included. Tablets and granules are preferred oral administration forms, and these may be coated. Injectables can be prepared in conventional forms, either as liquid solutions or suspensions, solid forms suitable for solution or suspension in liquid prior to injection, or as emulsions.

The exact amount of the pharmaceutical additive will vary from subject to subject, depending on the species, age, weight, and general condition of the subject; the severity of the disease, infection, or condition that is being treated or prevented; the particular pharmaceutical additive used; and the mode of administration. The appropriate amount may be determined by one of ordinary skill in the art. In one embodiment, the pharmaceutical additive is present in the controlled release matrix system at levels of from about 0.1% to about 50% by weight, and preferably from about 0.1 to about 20% by weight, based upon the total weight of the controlled release matrix system taken as 100% by weight. This system can be used to treat humans and animals (wild and domestic).

The size and shape of the controlled release matrix system can vary depending upon the technique used to manufacture the original pellet used to generate the matrix system. In one embodiment, the matrix system can be a granule or sphere, with exemplary sizes of from about 0.1 mm to about 50 mm, preferably from about 0.1 mm to about 10 mm, and more preferably from about 0.5 mm to about 5 mm in diameter.

A wide variety of agricultural additives can be used in the inventive controlled release matrix systems. Exemplary agricultural additives were discussed previously. The amount of the agricultural additive that can be incorporated into the matrix system can vary depending upon the agricultural additive and the rate of release of the additive. In one preferred embodiment, the controlled release matrix system comprises from about 0.1% to about 50% by weight of the agricultural additive, preferably from about 0.1% to about 30% by weight of the agricultural additive, and more preferably from about 0.1% to about 20% by weight of the agricultural additive, based upon the total weight of the matrix system taken as 100% by weight.

The controlled release matrix system containing an agricultural additive can be dispensed by techniques known in the art for the administration of agricultural, garden, or lawn chemicals. The system can be used to treat plants (agricultural, garden, lawn, etc.) and/or soil.

The time required to release the additive from the controlled release matrix system can be varied depending upon the cellulose ester and additive used. Once the initial release of the additive occurs, the duration of release of the additive can also vary depending upon the cellulose ester and additive employed. The duration of release (i.e., the time for substantially all of the additive to escape the matrix) can be from days to years. In one embodiment, a small amount of plasticizer or surfactant can be incorporated into the controlled release matrix system to modify the release profile. In another embodiment, a small amount of residual swelling agent may be present in the controlled release matrix system.

### Preparation of an Indicator Matrix System

The compounded cellulose esters can also be used to form an indicator matrix. Exemplary indicators for temperature, pH, etc., were discussed previously.

### EXAMPLES

The following examples set forth preferred methods in accordance with the invention. It is to be understood, however, that these examples are provided by way of illustration and nothing therein should be taken as a limitation upon the overall scope of the invention.

### Test Methods

1. Gel Permeation Chromatography (GPC) for Determining Molecular Weight

The eluent is N-methylpyrrolidone (NMP) with 1% by weight acetic acid. The temperature was 40° C., and the flow rate was 0.8 ml/min. The columns used were Polymer Laboratories 10 μm PLGel, one 50×7.5 mm guard column and one 300×7.5 mm Mixed B analytical column, and the detector was refractive index. A sample was prepared by dissolving 25 mg polymer in 10 ml NMP+10 μl toluene and adding a flow rate marker. The sample injection volume was 20 μl. Molecular weight was reported as polystyrene equivalents using monodisperse polystyrene standards.

2. Color Analysis

Samples were dissolved in 90/10 (vol/vol) methylene chloride/methanol at a 15% solids level, then cast to make a 5-mil thick film. Transmission of the film sample was measured by a Perkin-Elmer Lambda 950 UV-visible spectrophotometer, and the value of % transmission at 400 nm was used as a value to indicate yellowing of the sample.

3. Analysis for Plasticizers and Additives

The sample was weighed, spiked with a known amount of an internal standard, and dissolved in methylene chloride. The cellulose ester was precipitated from solution by the addition of a nonsolvent, leaving the plasticizers and stabilizers in the liquid phase. The sample was filtered, and the liquid analyzed by gas chromatography.

4. Gas Chromatography (GC) Procedures

Gas Chromatography was performed on a HP6890 gas chromatograph equipped with a DB-1301(J&W) 30M×0.32 mm×0.25 μm analytical column and flame ionization detector (FID). The carrier gas was helium at 150 ml/min. split flow, with a 15° C./min. ramp from 40° C. to 250° C.

5. Inductively Coupled Plasma Optical Emission Spectroscopy (ICP-OES)

With this procedure, a sample was prepared by digesting the material in trace-metal grade HNO₃. An internal standard was added, and the sample was aspirated into an Argon inductively coupled plasma. The plasma atomizes and excites the elements present in the sample. The resulting emission from the excited state was then detected and used to quantify the concentration of those elements in solution based on a comparison of the response to that of standards of known concentration.

6. Profile IR Procedure

Profile infrared spectroscopy (Nicolet Nexus 670 spectrophotometer coupled with a Nic-Plan IR Microscopewas) used to qualitatively detect the presence of additive throughout the pellet. The pellet sample was embedded in epoxy then microtomed to give a slice from the middle of the pellet. Infrared absorbance was measured at three points, near the edge, midway, and in the center of the pellet. Additive level was normalized to a value of 100 at the highest level.

### Example 1

### Infusion of Plasticizer and Stabilizer into Pellet

Cellulose triacetate (“CTA,” CA-436-80 from Eastman Chemical Company) (300 g) was combined with acetone (300 g) and diethyl phthalate (DEP) containing 1% tert-butyl phenol (150 g) in a 32-ounce glass jar. The jar was rolled for 16 hours, at which time all of the liquids had absorbed into the cellulose triacetate pellets, and the pellets had swelled to fill the jar. The pellets were poured into a shallow pan and allowed to air dry at room temperature for 78 hours. The dry pellets weighed 446 g. This resulted in pellets with a theoretical plasticizer content of 32.8% plasticizer. The dry pellets were free-flowing and similar in shape to the original pellets, although slightly larger in size and slightly more irregular in shape. The pellets were submitted for plasticizer analysis, which gave 32.36% DEP and 0.17% tert-butyl phenol. This demonstrates that the plasticizer and stabilizer were both infused into the pellet.

### Example 2

### Infusion of Plasticizer into Pellet

Cellulose triacetate (CA-436-80 from Eastman Chemical Company) (440 g) was combined with acetone (450 g) and triphenylphosphate (60 g) in a 32-ounce glass jar. The jar was rolled for 24 hours, at which time all of the liquids had absorbed into the cellulose triacetate pellets, and the pellets had swelled to fill the jar. The pellets were then poured into a shallow pan and allowed to air dry at room temperature followed by drying in a forced air oven at 60° C. for 6 hours. The dry pellets weighed 506 g, which agrees with the target 12% plasticizer level. The dry pellets were free-flowing and similar in shape to the original pellets, although slightly larger in size and slightly more irregular in shape.

### Example 3

### Infusion of UV Stabilizer into Pellet

Cellulose triacetate (CA-436-80 from Eastman Chemical Company) (200 g) was combined with 200 g acetone and 1.0 g Tinuvin7 292 (UV stabilizer available from Ciba) and 1.0 g Tinuvin7 1130 (UV Absorber available from Ciba) in a 32-ounce glass jar. The jar was rolled for 15 hours, at which time all of the liquids had absorbed into the cellulose triacetate pellets, and the pellets had noticeably increased in size. The free-flowing pellets were poured into a shallow dish and allowed to air dry at room temperature for 78 hours.

### Example 4

### Melt Processing Pellets Infused with Plasticizer and Stabilizer

Cellulose triacetate (CA-436-80 from Eastman Chemical Company) (400 g) was combined with acetone (300 g) and diethyl phthalate (200 g) in a 32-ounce glass jar. The jar was rolled for 6 hours, at which time nearly all of the liquids had absorbed into the cellulose triacetate pellets, and the pellets had swelled to fill the jar. The pellets were poured into a shallow pan and allowed to air dry at room temperature for 24 hours. The dry pellets weighed 600 g, which means the pellets contained 33% plasticizer. The dry pellets were free-flowing, similar in shape to the original pellets, and slightly larger in size. The infused pellets were extruded on an APV extruder at 265° C. to make a strand that was visually observed to have a good color and a glossy surface.

### Example 5

### Melt Processing CTA/DEP/TPP/Stabilizer-Infused Pellets

Cellulose triacetate (CA-436-80 from Eastman Chemical Company) (500 g) was combined with acetone (300 g), diethyl phthalate (48 g), triphenyl phosphate (48 g), and a blended stabilizer mixture (5 g, a phosphite anti-oxidant and an epoxidized, oil-based thermal stabilizer) in a 32-ounce glass jar. The jar was rolled for 12 hours, at which time all the liquids had absorbed into the cellulose triacetate pellets, and the pellets had swelled to fill the jar. The pellets were poured into a shallow pan and allowed to air dry at room temperature for 24 hours. The dry pellets weighed 617 g. The dry pellets were free-flowing, similar in shape to the original pellets, and slightly larger in size. The infused pellets were extruded through an APV extruder at 265° C. to make a strand with good color and a glossy surface.

### Example 6

### Melt Processing CTA/TPP/Stabilizer-Infused Pellets

Cellulose triacetate (CA-436-80 from Eastman Chemical Company) (400 g) was combined with acetone (300 g), triphenyl phosphate (100 g), and a blended stabilizer mixture (2 g, a phosphite anti-oxidant and an epoxidized, oil-based thermal stabilizer) in a 32-ounce glass jar. The jar was rolled for 12 hours, at which time all the liquids had absorbed into the cellulose triacetate pellets, and the pellets had swelled to fill the jar. The pellets were poured into a shallow pan and allowed to air dry at room temperature for 24 hours. The dry pellets weighed 617 g. The dry pellets were free-flowing, similar in shape to the original pellets, and slightly larger in size. The infused pellets were then extruded through an APV extruder at 260-265° C. to make a strand with good color and a glossy surface.

### Example 7

### Film Extrusion of CTA/DEP/TPP/Stabilizer-Infused Pellets

Cellulose triacetate pellets (CA-436-80 from Eastman Chemical Company) (800 g) were added to a mixture of acetone (800 g), diethyl phthalate (50 g), triphenyl phosphate (150 g), and a stabilizer mixture (8 g, aphosphite anti-oxidant and an epoxidized, oil-based thermal stabilizer) in a 64-ounce glass jar. The jar was rolled for 24 hours, at which time all the liquids had absorbed into the cellulose triacetate pellets, and the pellets had swelled to nearly fill the jar. The dry-to-the-touch, free-flowing pellets were poured into a shallow pan and allowed to air dry at room temperature for 24 hours. The air-dried pellets were then further dried in an oven at 50° C. for 6 hours. The dry pellets were free-flowing, similar in shape to the original pellets, and slightly larger in size. The treated pellets were then extruded at 270° C. through a single screw extruder equipped with a 6-inch film die. The film was visually observed to have good color and clarity.

### Example 8

### Evaluation of Plasticizers in CTA

In this procedure, 40 g cellulose triacetate was exposed to a mixture of 30 g acetone and 30 g of a plasticizer for 16 hours. The excess liquid was drained away. The pellets were then blotted and dried at 25° C. for 24 hours, followed by drying in a forced air oven at 50° C. for 24 hours. The weight after drying is indicative of plasticizer uptake, and can, therefore, be used to compare the different plasticizer affinities and diffusibilities. Table 1 sets forth the various plasticizers that were tested as well as the plasticizer uptake.

TABLE 1

| | TOTAL WT. | | |
|---|---|---|---|
| | AFTER | PLASTICIZER | WT % |
| | EXPOSURE AND | UPTAKE | PLASTICIZED |
| PLASTICIZER | DRYING (g) | (g) | ABSORBED |
| Triacetin | 69.62 | 29.62 | 99% |
| Triethyl | 66.19 | 26.19 | 87% |
| citrate (TEC) | | | |
| Triphenyl | 63.18 | 23.18 | 77% |
| phosphate (TPP) | | | |
| Diethyl | 62.53 | 22.53 | 75% |
| phthalate (DEP) | | | |
| Acetyl triethyl | 61.44 | 21.44 | 71% |
| citrate (ATEC) | | | |
| Tripropionin | 59.49 | 19.49 | 65% |
| Glucose Penta | 56.57 | 16.57 | 55% |
| Propionate (GPP) | | | |
| Butyl Phthalyl | 53.69 | 13.69 | 46% |
| Butyl Glycolate | | | |
| PEG 400 | 53.65 | 13.65 | 46% |
| Dibutyl | 52.42 | 12.42 | 41% |
| phthalate (DBP) | | | |
| Diisobutyl | 49.33 | 9.33 | 31% |
| adipate (DIBA) | | | |
| PPG 425 | 48.50 | 8.50 | 28% |
| Texanol | 47.30 | 7.30 | 24% |
| isobutyrate | | | |
| TXIB | | | |
| Diisononyl | 45.30 | 5.30 | 18% |
| phthalate | | | |
| (DINP) | | | |
| bis(2-ethyl | 44.72 | 4.72 | 16% |
| hexyl) | | | |
| adipate (DOA) | | | |
| tris(2-ethyl | 44.16 | 4.16 | 14% |
| hexyl) | | | |
| trimellitate | | | |
| (TOTM) | | | |
| TPP/DEP 1:2 | 62.1 | 22.1 | 73% |
| TPP/DEP 1:1 | 61.7 | 21.7 | 72% |
| TPP/DEP 2:1 | 61.2 | 21.2 | 71% |

### Example 9

### Evaluation of Swelling Agents in CTA

In this example, 200 g cellulose triacetate was exposed to 150 g diethyl phthalate (DEP) plasticizer and 150 g of a swelling agent for 16 hours. The excess liquid was drained away. The pellets were then blotted and dried at 25° C. for 24 hours, followed by drying in a forced air oven at 50° C. for 24 hours. The weight after drying is indicative of plasticizer uptake, and was used to compare the different swelling agents. Table 2 sets forth the various swelling agents that were tested as well as the plasticizer uptake.

TABLE 2

| | TOTAL WT. AFTER | APPROXIMATE |
|---|---|---|
| | EXPOSURE AND DRYING | DEP UPTAKE |
| SWELLING AGENT | (g) | (g) |
| Acetic acid | 323.4 | 123.4 |
| Acetone | 322.6 | 122.6 |
| Methyl acetate | 313.6 | 113.6 |
| Acetonitrile | 274.2 | 74.2 |
| Methyl alcohol | 227.1 | 27.1 |
| Methyl ethyl ketone | 224.3 | 24.3 |
| (MEK) | | |
| Turkey red oil | 205.2 | 5.2 |
| Ethyl acetate | 220.6 | 20.6 |
| Tetrahydrofuran (HF) | 204.5 | 4.5 |
| diethylene glycol | 201.7 | 1.7 |
| monomethyl ether | | |
| Ethyl alcohol | 200.8 | 0.8 |
| p-Xylene | 200.8 | 0.8 |
| Benzene | 200.4 | 0.4 |
| o-Xylene | 200.0 | 0.0 |
| Toluene | 200.0 | 0.0 |

The most effective swelling agents for cellulose triacetate were acetone, methyl acetate, and acetic acid. Acetonitrile had moderate effectiveness in this experiment, while methanol, methyl ethyl ketone (MEK), and ethyl acetate had a small effect on plasticizer uptake. The samples with less than a 5 gram increase in weight (which would correspond to less than 3% of the available plasticizer being incorporated) are very poor swelling agents for this cellulose triacetate/DEP system. Some of these liquids, such as the Turkey Red oil and DEP, are very viscous and sticky and tend to cling to the pellets, which may give a falsely high DEP uptake value. The samples with no swelling agent or poor swelling agents demonstrated the lack of infusion of additives in the absence of an appropriate swelling agent. Profile IR analysis of the pellets treated with DEP and no swelling agent showed a very thin layer of DEP present only on the pellet surface, and no DEP in the interior of the pellet. The pellets that used acetone as a swelling agent were also tested by the profile IR method, and these showed plasticizer throughout the pellet cross-section.

### Example 10

### CTA/Optical Brightener

Cellulose triacetate (CA-436-80 available from Eastman Chemical Company) (200 g) was combined with 200 g acetone and 1 g of Eccowhite Optical Brightener (available from Eastern Chemical Company) in a 32-ounce glass jar. The jar was rolled for 7 hours, at which time all of the liquids had absorbed into the cellulose triacetate pellets, and the pellets had noticeably increased in size. The pellets were then poured into a shallow dish and allowed to air dry at room temperature. Under UV lamp (at wavelengths of 254 nm or 366 nm), the pellets fluoresced intense blue.

### Example 11

### CTA/Complex Fragrance

Cellulose triacetate (CA-436-80 available from Eastman Chemical Company) (40 g) was combined with 30 g acetone and 0.4 g of a fruity fragrance concentrate (Universal Fragrance Corporation #557921) in an 8-ounce glass jar. The jar was rolled for 16 hours, at which time all of the liquids had absorbed into the cellulose triacetate pellets, and the pellets had noticeably increased in size. The pellets were then poured into a shallow dish and allowed to air dry at room temperature for 78 hours. The pellets had a faint fruity smell.

### Example 12

### CTA/Vanillin (Fragrance)

Cellulose triacetate (CA-436-80 available from Eastman Chemical Company) (200 g) was combined with 200 g acetone, 22 g DEP, and 2.0 g vanillin in a 32-ounce glass jar. The jar was rolled for 15 hours, at which time all of the liquids had absorbed into the cellulose triacetate pellets, and the pellets had noticeably increased in size. The free-flowing pellets were then poured into a shallow dish and allowed to air dry at room temperature for 24 hours, and after air drying they smelled noticeably of vanilla. The pellets were then further dried at 50° C. for 4 hours, after which they still smelled noticeably of vanilla.

### Example 13

### CTA/Dye

Cellulose triacetate (CA-436-80 available from Eastman Chemical Company) (200 g) was combined with 200 g acetone, 20 g DEP, and 0.1 g alizarin (CAS [72-48-0], available from Aldrich 33,317-4 tech grade 85%) in a 32-ounce glass jar. The jar was rolled for 15 hours, at which time all of the liquids had absorbed into the cellulose triacetate pellets. The pellets had turned brick red in color and noticeably increased in size. The free-flowing pellets were poured into a shallow dish and allowed to air dry at room temperature for 24 hours, then dried at 50° C. for 12 hours. The pellets remained a brick-red color after drying. Treating the alizarin-infused pellets with acetic acid slowly turned the pellets from brick red to golden yellow. Under UV light (wavelength of 366 nm), the infused pellets fluoresced red-orange, while the acid-treated, infused pellets fluoresced yellow-orange.

### Example 14

### CTA/pH Indicator

Cellulose triacetate (CA-436-80 available from Eastman Chemical Company) (200 g) was combined with 200 g acetone and 2.0 g phenolphthalein in a 32-ounce glass jar. The jar was rolled for 15 hours, at which time all of the liquids had absorbed into the cellulose triacetate pellets, and the pellets had noticeably increased in size. The free-flowing pellets were poured into a shallow dish and allowed to air dry at room temperature for 24 hours, then at 50° C. for 12 hours. The pellets turned pink when placed in a 0.05 M solution of sodium hydroxide. The mixture could then be decanted or filtered to recover and re-use the indicating pellets.

### Example 15

### CA/Isopropanol/DEP

Cellulose acetate (CA-320S available from Eastman Chemical Company) (14 g) was combined with isopropanol (14 g) and diethyl phthalate (14 g) in an 8-ounce glass jar. The jar was rolled for 16 hours, at which time all of the liquids had absorbed into the cellulose triacetate pellets, and the pellets had swelled to fill the jar. The pellets were then poured into a shallow pan and allowed to air dry at room temperature for 24 hours, then dried at 50° C. for 12 hours. The dry pellets weighed 27.3 g. This yielded pellets with a theoretical 49% by weight plasticizer content. The dry pellets were free-flowing and similar in shape to the original pellets.

### Example 16

### CA/Acetone/Triacetin

Cellulose acetate (CA-320S available from Eastman Chemical Company) (40 g) was combined with acetone (30 g) and triacetin (30 g) in an 8-ounce glass jar. The jar was rolled for 16 hours, at which time all of the liquids had absorbed into the cellulose triacetate pellets, and the pellets had swelled to fill the jar. The pellets were then poured into a shallow pan and allowed to air dry at room temperature for 24 hours, then dried at 50° C. for 12 hours. The dry pellets weighed 58.6 g. This resulted in pellets having a theoretical 31% by weight plasticizer content. The dry pellets were free flowing and similar in shape to the original pellets.

### Example 17

### CA/Methanol/DEP

Cellulose acetate (CA-320S, DS_{Ac} ˜1.7-1.8, available from Eastman Chemical Company) (10 g) was combined with methanol (15 g) and diethyl phthalate (10 g) in an 8-ounce glass jar. The jar was rolled for 16 hours, at which time the pellets had completely dissolved. This demonstrated that methanol is not a suitable swelling agent for CA-320S because it has too much solvating power toward the CA-320S.

### Example 18

### Dissolution of Treated Pellets

This procedure was carried out to compare making a dope with the treated cellulose triacetate pellets with the prior art methods of making a dope. Under prior art, lab scale conditions for making a cellulose triacetate dope, the solid cellulose triacetate is added to a solution containing the desired solvent, plasticizer, and any other additives. After combining the mixture in a jar, the contents are mixed by rolling the jar on parallel rollers. Under typical conditions, the triacetate solids dissolve within about 24 hours. In this study, control triacetate pellets prepared by this prior art procedure were compared to treated triacetate pellets in which the plasticizer and additives were previously infused by using a swelling agent.

The control and experimental samples were both set up such that the final solution would be composed of 90 g cellulose triacetate (CA-436-80, available from Eastman Chemical Company), 10 g triphenyl phosphate, 1 drop (<0.05 g) blue dye (a phthalocyanine-based dye), and 567 g 90/10 (vol/vol) CH₂Cl₂/CH₃OH (target 15% solids dope). The blue dye was added to the solvent to better visualize the progression of dissolution, and it would not be expected to affect dissolution.

For the control sample, A, the cellulose triacetate was used as manufactured. For the experimental sample, B, the procedure used 100.0 g treated pellets that had previously been infused with plasticizer and stabilizer to a level of 10% triphenyl phosphate. Both pellet samples were dried at 60EC for 16 hours prior to the dissolution experiment.

For control sample A, the 10 g triphenyl phosphate and 1 drop blue dye were dissolved in 567 g 90/10 (vol/vol) CH₂Cl₂/CH₃OH in a quart jar. For the experimental sample B, the liquids in the quart jar were 567 g 90/10 (vol/vol) CH₂Cl₂/CH₃OH and 1 drop blue dye.

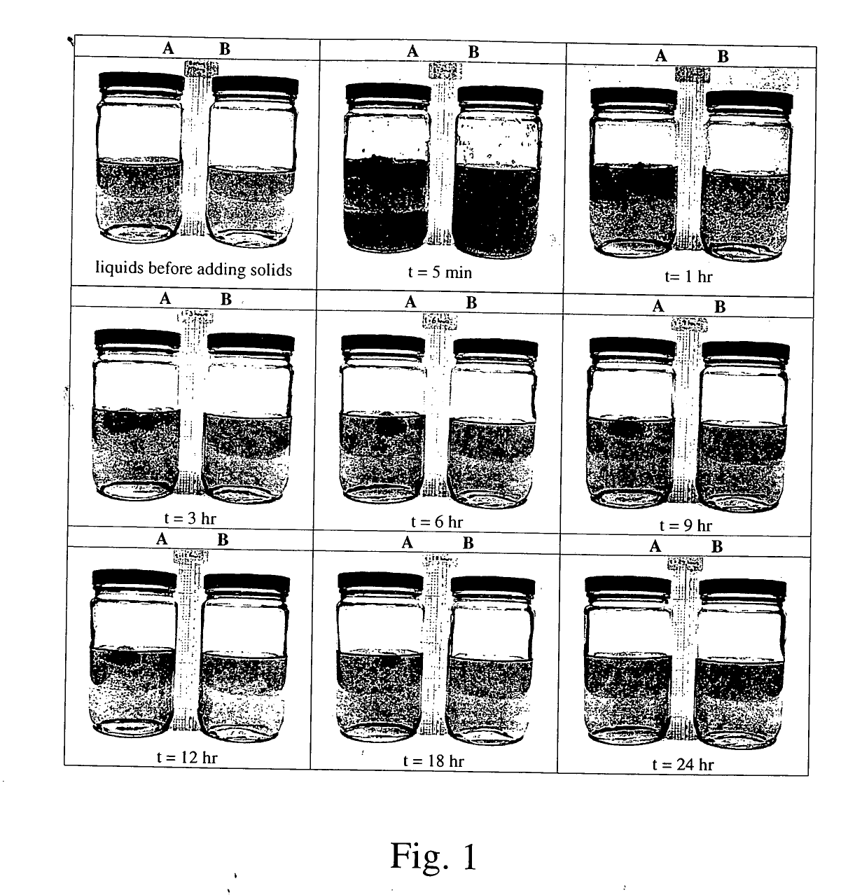

The moment of adding the pellets to their respective jars of liquids was defined as time=0 (See FIG. 1a; in each 2-jar image, control Sample A is on the left, while experimental Sample B is on the right). The pellets were added quickly, and each jar was shaken by hand immediately after adding the pellets to minimize clumping of the pellets. The pellets in the control sample A clumped and stuck to the side of the jar, so sample A was given additional poking and stirring with a long spatula to try to break up the clumps. Sample B pellets dispersed initially and did not need to be broken apart manually. After 5 minutes of shaking by hand, the photograph shown in FIG. 1a at time=5 minutes was taken, and the jars were then transferred to parallel rollers for mixing, which is a typical method for mixing cellulose ester dopes. Both jars were mixed by rolling throughout the experiment and were removed periodically to photograph the progression of dissolution over a time span of 23 hours. To photograph the samples, the jars were removed from the mixing rollers and taken to the same location with fixed lighting and backdrop. Each photograph took about 2 minutes, and to offset this time of not mixing, each jar was shaken by hand for 5 seconds upon removing from the rollers and also before returning to the rollers.

At time=1 hour, control sample A had a few larger lumps, while experimental sample B had many dispersed small gels (FIG. 1a). After 6 hours, the gels were reduced in size, and the tiny gels in sample B were barely visible (FIG. 1b). At time=9 hours, the gels in sample A were about 2 cm×2 cm×5 cm, while the gel in sample B was essentially dissolved, having no gel visible to the naked eye. After 12 hours, the gels in sample a were becoming more transparent. At time=24 hours, the undissolved gel in control sample A was nearly dissolved and was about 1 cm³. At time=27 hours, both Samples A and B were completely dissolved and were identical solutions containing 90 g CTA (CA-436-80), 10 g triphenyl phosphate, 1 drop blue dye, and 567 g 90/10 (vol/vol) CH₂Cl₂/CH₃OH.

The control Sample A completely dissolved within about 27 hours as expected and as is typical for making triacetate dopes by prior art methods. The treated, pre-infused pellets dissolved much faster, showing no visible gels after only 9 hours. The treated pellets exhibited a surprising improvement in their easier initial dispersion in the solvent, and in remaining dispersed and dissolving markedly faster than the untreated cellulose triacetate pellets for a given set of conditions. This dissolution improvement would be advantageous in making dopes used for spinning fibers, solution cast films, coatings, and the like.

In two other dissolution comparison studies, the control cellulose triacetate pellets dissolved in 15 to 24 hours while the treated pellets dissolved in 9 to 12 hours. Dissolution time can be affected by temperature, solids/solvent ratio, plasticizer level, and initial dispersion of the pellets, but in each case the treated plasticizer infused pellets dissolved faster than the control pellets.

### Example 19

### Melt Spinning of Infused Cellulose Triacetate Pellets

Cellulose triacetate pellets (CA-436-80, available from Eastman Chemical Company) (300 g) were added to a 64-ounce jar containing 67 g diethyl phthalate (DEP), 33 g triphenyl phosphate (TPP), 3 g proprietary stabilizer blend (a phosphite anti-oxidant and an epoxidized, oil-based thermal stabilizer), and 300 g acetone. The mixture was blended by rolling the jar on parallel motorized rollers. The liquids had mostly absorbed in about 4 hours, but the mixture was left to roll overnight. The swelled pellets were air dried at 25° C., then dried 3 hours in a vacuum oven at 65° C. The pellets were additionally dried overnight in a vacuum oven at 60° immediately prior to spinning. Melt spinning was carried out on a laboratory scale, melt spinning system with a gear pump and 16-hole spinneret. The barrel temperature was set to 270′. Fiber was melt spun, both with and without drawing, to yield an off-white fiber.

### Example 20

### Melt Spinning of Infused Cellulose Acetate Pellets

Cellulose acetate (CA320S, available from Eastman Chemical Company) was washed and restabilized by adding calcium hydroxide to a slurry of pellets in water to yield 99 ppm Ca. The level of calcium in a cellulose ester sample was determined using Inductively Coupled Plasma Optical Emission Spectroscopy (ICP-OES).

These restabilized pellets (300 g) were added to a 64-ounce jar containing 75 g triacetin (plasticizer), 3 g proprietary stabilizer blend (a phosphite anti-oxidant and an epoxidized, oil-based thermal stabilizer), and 300 g acetone. The jar was shaken by hand for 2 minutes and then mixed by rolling the jar on parallel motorized rollers. The liquids had completely absorbed within 15 minutes. The jar was left to roll overnight. The infused pellets were air dried under ambient (25° C.) conditions, then dried for 3 hours in a vacuum oven at 65° C. The pellets were additionally dried overnight in a vacuum oven (20 mm Hg) at 60° C. immediately prior to spinning. Melt spinning was carried out on a laboratory scale, melt spinning system with a gear pump and 16-hole spinneret. The barrel temperature was set to 260° C. Fiber was melt spun, both with and without drawing, to yield an off-white fiber.

### Example 21

### Cellulose Acetate Phthalate With Dye and Fragrance

Cellulose acetate phthalate (40 g) was added to a 16-ounce jar containing a mixture of 30 g ethanol, 10 g isopropyl alcohol, 1 g triacetin, 4 g citrus fragrance (Universal Fragrance Co., “Citrus Melange”), and the ink from a yellow marker (<0.01 g). The mixture was shaken for 10 minutes, at which time all of the liquids had absorbed into the pellets. The swelled pellets were pale yellow in color, with some pellets being more translucent and some being more opaque. The swelling agents were evaporated by opening the jar and exposing the contents to ambient (25°) conditions. The pellets were stirred periodically to minimize clumping as they dried. The dried pellets were pale yellow with a pleasant citrus fragrance.

### Example 22

### Cellulose Acetate Phthalate with Dye and Fragrance

Cellulose acetate phthalate (40 g) was added to a 16-ounce jar containing a mixture of 17 g ethanol, 15 g isopropyl alcohol, 4 g grape fragrance (“Add a Scent” brand fragrance, available from Darice Inc., fragrance oil for candle and soap making), and the ink from a red permanent marker (<0.01 g). The mixture was shaken for 10 minutes, at which time all of the liquids had absorbed into the pellets. The swelled pellets were pink in color, with some pellets being more translucent and some being more opaque. The swelling agents were evaporated by opening the jar and exposing the contents to ambient (25° C.) conditions. The drying pellets were stirred periodically to minimize clumping. The dried pellets were pink with a pleasant fruity fragrance.

### Example 23

### Recovering the Swelling Agent

Cellulose triacetate pellets (CA436-80S, available from Eastman Chemical Company) (90 g) were added to a 16-ounce jar containing 80 g acetone and 10 g diethyl phthalate. The jar was rolled overnight. The swelled pellets were placed in a 500-ml, round bottom flask and placed on a rotary evaporation unit (Büchi Rotavapor RE121, equipped with ice water cooled condenser, water aspirator (50 mm Hg), and heated bath). The heating bath was set to 65° C., and the motor to 55 rpm. After 30 minutes, 31.5 g of swelling agent was recovered, and after about 1 hour the dried pellets weighed 108.6 g. This experiment demonstrated that, by using a vacuum and a chilled water cooled condenser, partial recovery of the swelling agent can be achieved while drying the pellets.

### Example 24

### Recovering the Swelling Agent

Cellulose acetate pellets (CA320S, available from Eastman Chemical Company) (90 g) were combined with acetone (100 g) and triacetin plasticizer (10 g) in a 16-ounce jar, and the jar was rolled on parallel rollers. All the liquids absorbed within 10 minutes. The jar was left to roll overnight. The swelled pellets were transferred to a 1,000-ml round bottom flask, and the flask was placed on a rotary evaporation unit (Büchi Rotavapor RE121, equipped with ice water cooled condenser, water aspirator, and heated bath). The heating bath was set to 55° C., and the motor was set to 55 rpm. After 30 minutes, 51 g swelling agent was recovered, and after about 1 hour the pellets weighed 109.6 g. This experiment demonstrated that using a vacuum and a chilled water cooled condenser allowed for partial recovery of the swelling agent while drying the pellets.

### Example 25

### Swelling Agent Recovery from Swelled Compounded Pellets

Cellulose triacetate (800 g, CA436-80S) was combined in a one gallon jar with a solution of 700 g acetone, 100 g methyl acetate, 150 g triphenyl phosphate (TPP), and 50 g diethyl phthalate (DEP). The mixture was rolled in the jar overnight (about 16 hours). This procedure was repeated to give four batches of swelled cellulose triacetate pellets. For the swelling agent removal phase, the swelled pellets were divided into eight batches in order to fit into a 3-liter flask on a Büchi rotary evaporation unit. The swelling agent was removed using water aspirator vacuum, a 50° C. bath temperature, a rotation speed of 20 rpm, and 1 hour time per batch. The swelling agent was stripped from the pellets for one hour on the rotary evaporation apparatus, but not exhaustively evaporated, which would have taken longer than one hour. A total of 2,123 g swelling agent was recovered (66.4% of the theoretical total swelling agent). The removed swelling agent was analyzed by directly injecting the liquid into a gas chromatograph (GC) to determine the acetone to methyl acetate ratio and to determine the amount of plasticizer that was stripped during swelling agent removal. GC analysis of the recovered liquid gave a composition of 92.23% acetone (theoretical 87.5%); 7.74% methyl acetate (theoretical 12.5%); and 3.04 ppm diethyl phthalate. No triphenyl phosphate was detected.

The GC analysis indicated that there was an increased acetone to methyl acetate ratio in the recovered swelling agent. It should be noted that the solvent stripping was not done with rigorous trapping and was not carried out to completion, both factors that could affect the precise ratio of acetone to methyl acetate. Importantly, the low level of plasticizers, only 3 ppm diethyl phthalate and no detected triphenyl phosphate, in the recovered swelling agent is highly desirable, and indicated that the plasticizer was essentially remaining with the polymer. The low contamination of plasticizer in the stripped swelling agent allows for a more accurate prediction of the plasticizer level in the polymer and reuse of the swelling agent without requiring extensive cleanup.

### Example 26

### Recovering and Reusing the Swelling Agent

Cellulose triacetate pellets (CA436-80S, 90 g) were added to a 16-ounce jar containing 90 g acetone and 10 g triacetin. The mixture was placed on motorized parallel rollers for mixing. Most of the swelling agent had absorbed into the polymer after 1 hour. The jar was left to roll overnight (about 14 hours).

The swelled pellets were placed in a 500-ml round bottom flask and placed on a rotary evaporation unit (Büchi Rotavapor RE121, equipped with ice water cooled condenser, water aspirator, and heated bath). The heating bath was set to 55° C., and the motor to 55 rpm. After 30 minutes, 53 g swelling agent was recovered, and the pellets weighed 107.3 g. Plasticizer analysis indicated 9.8% triacetin.

In an 8-ounce jar, 50 g of the recovered acetone were combined with 5 g of triacetin plasticizer. To this mixture, 45 g cellulose triacetate pellets (CA436-80S) were added, and the mixture was rolled in the jar to mix. Most of the swelling agent had absorbed into the polymer after 1 hour. The jar was left to roll overnight, about 14 hours. The swelled pellets were placed in a 500-ml round bottom flask, which was placed on a rotary evaporation unit (Büchi Rotavapor RE121, equipped with ice water cooled condenser, water aspirator, and heated bath). The heating bath was set to 55° C., and the motor was set to 55 rpm. After 30 minutes, 21 g acetone was recovered, and the pellets weighed 52.4 g. Plasticizer analysis indicated 10.2% triacetin.

This experiment demonstrated that the swelling agent can be recovered, and this recovered swelling agent can be recycled as a swelling agent for use with a new batch of polymer and additives. The recovery and reuse of the swelling agent reduces the expense of the swelling method for infusing additives into polymers.

### Example 27

### Mixing and Swelling Agent Recovery Together on a Rotary Evaporation Unit

In a 500-ml round bottom flask, 60 g acetone, 8 g diethyl phthalate (DEP), and 72 g cellulose triacetate (CA436-80S, available from Eastman Chemical Company) were combined, and the flask was placed on a rotary evaporation unit (Büchi Rotavapor RE121). In the mixing phase of the experiment, the unit was initially set to rotate the flask above the water bath and without a vacuum. The unit was set to 160 rpm for 5 minutes, then reduced to 80 rpm for 10 minutes, and finally reduced to 60 rpm for 15 minutes. After 30 minutes of mixing, the pellets were swelled and rubbery, and the flask was then lowered into the 55° C. bath to mix another 30 minutes, still at ambient pressure. After a total mixing time of 1 hour, the vacuum was turned on to initiate the evaporation stage of the experiment. The water bath was set at 55° C., the rotation was set at 60 rpm, and a water aspirator vacuum and water cooled condenser were applied. After about 30 minutes the recovered acetone weighed 26.5 g, and after about 2 hours, the cellulose triacetate pellets weighed 82.7 g. Plasticizer analysis indicated 10.0% DEP.

### Example 28

### Mixing and Swelling Agent Recovery Together in a Distillation Flask

A 1,000-ml, three-neck, round bottom flask was equipped with a motorized stirring paddle, heating mantel, and water-cooled distillation condenser. To this flask, 90 g acetone, 6 g triphenyl phosphate (TPP), 6 g triacetin, and 88 g cellulose triacetate (CA436-80S, available from Eastman Chemical Company) were combined. The mixture was stirred for 40 minutes at which time the majority of the liquids had absorbed into the cellulose triacetate pellets, and the pellets were not clumped. The heating mantle was then turned on at a low temperature (about 40° C.), and the mixture was stirred an additional 20 minutes to complete the infusion phase. At this time, all free liquids had been absorbed into the pellets, and the pellets were dry to the touch, rubbery, and stirring freely. To begin the swelling agent evaporation phase, the stirring was maintained, the heating was increased to about 55° C., the vacuum valve was opened, and the distillation receiving flask was submerged in dry ice. The swelling agent distilled off the swelled pellets steadily, and after 2 hours the recovered acetone weighed 54.8 g. After about one additional hour with heating and vacuum, the cellulose triacetate pellets weighed 100.7 g. Plasticizer analysis indicated 6.2% triacetin and 6.0% TPP.

### Example 29

### Screening of Swelling Agents for Different Cellulose Esters

In this screening study, three different cellulose esters, a cellulose acetate (CA398-30), a cellulose acetate propionate (CAP141-20), and a cellulose acetate butyrate (CAB171-15), all available from Eastman Chemical Company, were used in their powder commercial form. Candidate swelling agents included a series of alcohols and esters. The candidate cellulose ester (20 g) was added to a 4-ounce jar (8 ounces for the CAP141-20) containing 20 g of the candidate swelling agent plus 2 g diethyl phthalate as a representative plasticizer. The jar was then rolled at room temperature to mix the components. The interaction of the swelling agent with the polymer was observed. The desired behavior for a suitable swelling agent is to swell and soften the polymer, without dissolving the polymer, such that the diffusion of additives into the polymer matrix is facilitated, and the shape and form of the polymer remains similar. Samples were observed after 16 hours and after 5 days. The observations are summarized in Table 3 below. The volume after exposure to the swelling agent was measured to give an indication of swelling. A swelling agent that is too strong tends to decrease the volume due to partial dissolution. Desired swelling is also indicated by the hardness and appearance of the polymer after exposure. If the volume has increased, but the polymer remains hard and gritty, then the swelling agent is too weak and is not a good candidate. Blends of the swelling agents that are too dissolving or too weak may also be suitable swelling candidates. For cellulose acetate CA398-30, the best candidates were methanol and propyl acetate. For the CAP141-20 and CAB171-15, butyl acetate gave the best swelling and softening. Butyl acetate or butyl acetate blended with a small amount of one of the weaker solvent alcohols are potential swelling candidates.

TABLE 3
Screening Summary

| | ESTER | | | | | |
|---|---|---|---|---|---|---|
| | CA398-30 IN | | CAP141-20 IN | | CAB171-15 IN | |
| SOLVENT OR | 4-OUNCE JAR | | 8-OUNCE JAR | | 4-OUNCE JAR | |
| SWELLING | VOLUME | | VOLUME | | VOLUME | |
| AGENT | (cm³) | COMMENTS | (cm³) | COMMENTS | (cm³) | COMMENTS |
| Control (No | 56 | | 84 | | 58 | |
| Solvent/Swell- | | | | | | |
| ing Agent) | | | | | | |
| Water | 113 | hard, gritty feel; slightly | 141 | clings to outside of jar; | 90 | packed on outside of jar; |
| | | softened after sitting | | gritty feel | | gritty hard |
| Methanol | 140 | soft powder | 136 | soft powder | 134 | soft powder |
| Ethanol | 140 | increasing hardness, | 128 | harder; gritty | 143 | increasing hardness, |
| | | grittiness | | | | grittiness |
| n-Propanol | 138 | increasing hardness, | 128 | harder; gritty | 132 | increasing hardness, |
| | | grittiness | | | | grittiness |
| n-Butanol | 100 | hardest, grittiest feel | 128 | harder; gritty | 132 | hardest, grittiest feel |
| Methyl | 72 | partially dissolved; soft, | 90 | partially dissolved soft ball | 68 | partially dissolved; very |
| Acetate | | balled up; after sitting: | | plus powder clinging to | | soft ball plus loose powder; |
| | | rubbery, shrunk to 49 cm³ | | outside of jar; after sitting: | | after sitting: rubbery |
| | | | | mostly dissolved (59 cm³) | | |
| Ethyl | 72 | partially dissolved; ball; after | 90 | partially dissolved soft ball | 66 | partially dissolved soft ball |
| Acetate | | sitting: firm and rubbery | | plus undissolved powder; | | with undissolved powder; |
| | | | | after sitting: half-dissolved | | after sitting: rubbery |
| n-Propyl | 140 | soft, fluffy | 102 | partially dissolved soft ball, | 85 | partially dissolved; harder, |
| Acetate | | | | plus undissolved powder; after | | rubbery ball with powder; |
| | | | | sitting: firm ball with some | | after sitting: hard, rubbery |
| | | | | transparency | | |
| n-Butyl | 132 | more gritty feel | 218 | initially fused, rubbery powder | 151 | initially fused, rubbery |
| Acetate | | | | (115 cm³); rubbed | | powder (94 cm³); rubbed |
| | | | | apart to small clumps and loose, | | apart to small clumps and loose, |
| | | | | fluffy powder (218 cm³); | | fluffy powder (151 cm³); |
| | | | | after sitting: particles remain | | after sitting: remains as separate/ |
| | | | | separate | | separable |

20 g cellulose ester with 20 g solvent/swelling agent plus 2 g diethyl phthalate plasticizer. Unless otherwise noted, the sample had a similar appearance and form after sitting 5 days.

### Example 30

### Comparative Examples

Cellulose acetate (100.0 g of the type specified in Table 4) was stirred into a 16-ounce jar containing a mixture of 5.0 g glycerol and the water or swelling agent indicated in Table 4. The CA398-30 samples were mixed in 32-ounce jars due to their lower bulk density. The control samples used 140 g water as a carrier for the glycerol, while the comparative samples utilized a swelling agent that provided swelling of the cellulose acetate and miscibility with the glycerol. The mixtures were rolled in their respective jars overnight (about 16 hours) on parallel motorized rollers, which provided a tumbling type of mixing. For each sample, any free liquid was drained, and the weight of this unabsorbed liquid was determined. The remaining solids were blotted for 30 seconds with a paper towel to remove any surface liquids, then spread into a shallow pan to dry at 25° C. for 6 hours. Following drying at 25° C., the samples were dried 24 hours at 50° C. under vacuum. A beaker containing 10.0 g glycerol was placed in the vacuum oven along with the samples, and the weight of this glycerol after 24 hours at 50° C. under vacuum was still 10.0 g. This lack of evaporation of glycerol in a beaker indicated that the drying step would not in itself cause a loss of glycerol from the samples. A sample whose weight fell short of the theoretical maximum of 105 g can be explained as having not incorporated all of the available 5 g of glycerol during the exposure step.

The resulting dry weight for each sample and the % glycerol found by plasticizer analysis are set forth in Table 4. For each type of cellulose acetate, the sample using water as a carrier had the lowest uptake of glycerol, while the glycerol uptake was higher in the samples using a swelling agent that is a good swelling agent match for the given type of cellulose acetate. The high free liquid and negligible weight gain in the water samples indicate that the glycerol was more superficial in these samples. The swelling method penetrated the additives into the particle such that they could not be easily washed or blotted away. Samples B, H, and N appeared to retain some residual swelling agent even after drying. The choice of a more volatile swelling agent or a hotter drying temperature could be used to minimize residual swelling agent.

TABLE 4
Comparison of Water vs. Swelling Agent for Incorporation
of Glycerol into Various Cellulose Acetates.

| | | | | DRY | |
|---|---|---|---|---|---|
| | | SOLVENT OR | | WEIGHT | |
| | CA TYPE | SWELLING AGENT | | (% glycerol) | COMMENTS |
| A | CA436-80S | 140 | g water | 99.8 g | ˜120 g excess liquid was drained |
| | | | | (0.0%) | off. |
| B | CA436-80S | 80 | g acetone | 107.5 g | Methanol was added to help dissolve |
| | | 5 | g methanol | (4.7%) | the glycerol. No free liquid. Rubbery |
| | | | | | swelled, dry-to-touch particles. |
| C | CA398-30 | 140 | g water | 100.0 g | No free liquid, but damp, “wet sand” |
| | | | | (4.4%) | feel. |
| D | CA398-30 | 100 | g methanol | 101.3 g | No free liquid. Slightly softened, |
| | | | | (5.1%) | damp feel. |
| E | CA398-30 | 84 | g methanol/ | 101.4 g | No free liquid. Some lumps and |
| | | 56 | g ethyl acetate | (5.0%) | sticking, but breaks up fairly easily. |
| F | CA394-60 | 140 | g water | 100.7 g | ˜70 g excess liquid drained off |
| | | | | (1.2%) | |
| G | CA394-60 | 100 | g methanol | 101.3 g | ˜20 g excess liquid drained off |
| | | | | (2.8%) | |
| H | CA394-60 | 60 | g methanol/ | 105.9 g | All liquids absorbed. Some |
| | | 40 | g ethyl acetate | (2.9%) | translucency in particles. |
| I | PR CA | 140 | g water | 98.8 g | ˜95 g excess liquid drained off |
| | | | | (0.7%) | |
| J | PR CA | 100 | g methanol | 102.5 g | 10 g excess liquid drained off |
| | | | | (4.6%) | |
| K | PR CA | 100 | g propyl acetate | — | Glycerol is not miscible in propyl |
| | | | | | acetate |
| L | PR CA | 100 | g ethyl acetate | — | Glycerol is not miscible in ethyl |
| | | | | | acetate |
| M | PR CA | 100 | g 70/30 methanol/ | 104.1 g | ˜1 g free liquid blotted off |
| | | | ethyl acetate | (4.5%) | |
| N | PR CA | 100 | g 60/40 methanol/ | 105.7 g | No free liquid. Nicely swelled, |
| | | | ethyl acetate | (5.6%) | rubbery, translucent. |

CA436-80S = cellulose triacetate, DS_{Ac} ˜2.8-2.9 (Eastman Chemical Co.); Physical form: rice-like pellets.
CA398-30 = cellulose acetate, DS_{Ac} ˜2.4-2.5 (Eastman Chemical Co.); Physical form: powder.
CA394-60S = cellulose acetate, DS_{Ac} ˜2.4-2.5 (Eastman Chemical Co.); Physical form: mixture of powder and irregular particles up to 5 mm size.
PR CA = cellulose acetate, DS_{Ac} ˜2.4-2.5 (“Primester Acetate Flake”); Physical form: irregular particles ˜20 mm × 5 mm in size.

### Example 31

### Comparative Example

For Samples A, C, E, and G, cellulose acetate (100 g of the type indicated in Table 5) was combined in a 32-ounce jar with a solution of 30 g triacetin, 10 g camphor, and 165 g benzene. The mixture was rolled overnight, about 16 hours, then any excess liquid was decanted off, and the weight noted. The remaining damp solid was opened to ambient (25° C.) conditions and allowed to stand and dry for 48 hours.

For Comparative Samples B, D, F, and H, cellulose acetate (100 g of the type indicated in Table 5) was combined in a 32-ounce jar with a solution 30 g triacetin and 10 g camphor dissolved in the swelling agent prescribed in Table 5. The mixture was rolled overnight, about 16 hours, and then any free liquids were decanted off, and their respective weights noted. The remaining solids were opened to ambient (25° C.) conditions and allowed to stand and dry 48 hours.

Within each pair of comparative examples, the samples using benzene, a non-swelling agent, had a smaller weight gain. Using instead a swelling agent that swells the cellulose acetate of interest, a higher absorption of plasticizer can be achieved. Furthermore, by selecting a swelling agent type and amount that completely absorbed into the cellulose ester during the exposure time, the processing step of draining off the excess liquids can be eliminated. The powdered CA398-30 (Sample C) did absorb all the benzene liquids, but the powder remained hard and gritty, which indicated that the liquid absorption was predominately a physical effect of the powdered sample form, and plasticizer uptake would therefore be expected to be more superficial. Upon drying, Sample C was nonuniform, with crusty areas and powdery areas. The plasticizer analysis also indicated a nonuniform distribution of plasticizer, with different submissions of the same sample yielding different plasticizer % values (entry C in Table 5). The cellulose acetate used in Sample F, with its similar acetyl level but lower surface area flake form, exaggerates this lack of swelling and poor plasticizer uptake when using benzene with a cellulose acetate in the DS 2.4 to 2.5 range.

For the set of examples described in Table 5, the plasticizer level was relatively high (40 g for 100 g CA) so the solubility characteristics of the plasticizer would be expected to contribute to the swelling effect of the solvent/additives or swelling agent/additives solution. This is evident by comparing Sample E in Table 4 with Sample D in Table 5, for 100 g CA398-30. With 5 g of the relatively poorly compatible glycerol, 140 g of 60/40 methanol/ethyl acetate worked well to swell the cellulose acetate. However, when the plasticizer was changed to 30 g triacetin and 10 g camphor, which is a higher level of a more solvating plasticizer blend, even 70/30 methanol/ethyl acetate made a mixture that partially dissolved the CA398-30. Therefore, for the 40 g of more compatible plasticizer, changing to 100% methanol made the mixture a more appropriate swelling blend for CA-398-30.

TABLE 5
Comparison of Benzene vs. Swelling Agent for Incorporating
Camphor and Triacetin into Various Cellulose Acetates

| | | | | | | DRY | |
|---|---|---|---|---|---|---|---|
| | | SOLVENT | | | | WEIGHT OF | |
| | | OR | | | | SOLIDS | |
| | | SWELLING | | DECANTED | | (% triacetin) | |
| | CA TYPE | AGENT | | LIQUID | | (% camphor) | COMMENTS |
| A | CA436-80S | 165 | g benzene | 196 | g | 100.0 g | Excess liquid drained off. |
| | | | | | | (0.0%) | No evidence of swelling. |
| | | | | | | (0.0%) | |
| B | CA436-80S | 80 | g acetone | 0 | g | 139.6 g | The pellets swelled and |
| | | | | | | (21.5%) | absorbed all liquids yielding |
| | | | | | | (6.4%) | free-flowing, dry-to-touch, |
| | | | | | | | rubbery pellets. |
| C | CA398-30 | 165 | g benzene | 0 | g | 129.2 g | All liquid held in the powder; |
| | | | | | | (18.5-31.6%) | The powder appeared |
| | | | | | | (2.3-2.5%) | somewhat translucent, and |
| | | | | | | | had the texture of wet sand. |
| D | CA398-30 | 98 | g methanol/ | 0 | g | 136.2 g | Partially dissolved. Dried to |
| | | 42 | g ethyl acetate | | | | chunks. Triacetin is a cold |
| | | | | | | | solvent plasticizer (pz) for |
| | | | | | | | cellulose diacetate, so the |
| | | | | | | | swelling agent needs to be |
| | | | | | | | less dissolving to achieve |
| | | | | | | | swelling without dissolving |
| | | | | | | | in the pz/swelling agent |
| | | | | | | | mixture. |
| E | CA398-30 | 110 | g methanol | 0 | g | 133.6 g | All liquids absorbed and |
| | | | | | | (21.8%) | powder has the spongy feel |
| | | | | | | (4.9%) | of swelling without |
| | | | | | | | dissolving. Some clumps |
| | | | | | | | were present, but these |
| | | | | | | | crumbled apart easily. |
| F | PR CA | 165 | g benzene | 171 | g | 106.3 g | Excess liquid drained off. |
| | | | | | | (5.6%) | Minimal swelling. |
| | | | | | | (1.0%) | |
| G | PR CA | 100 | g methanol/ | 1.3 | g | 138.8 g | Small amount of unabsorbed |
| | | 10 | g ethyl acetate | | | (21.7%) | liquid. Pellets partially |
| | | | | | | (6.4%) | translucent |
| H | CA320S | 165 | g benzene | 80.0 | g | 121.8 g | Excess liquid drained off. |
| | | | | | | (14.3%) | |
| | | | | | | (1.8%) | |
| I | CA320S | 140 | g acetone | 0 | g | 139.6 g | All liquids absorbed within 1 |
| | | | | | | (21.2%) | hour. |
| | | | | | | (6.5%) | |

CA436-80S = cellulose triacetate, DS_{Ac} ˜2.8-2.9 (Eastman Chemical Co.); Physical form: rice-like pellets.
CA398-30 = cellulose acetate, DS_{Ac} ˜2.4-2.5 (Eastman Chemical Co.); Physical form: powder.
CA394-60S = cellulose acetate, DS_{Ac} ˜2.4-2.5 (Eastman Chemical Co.); Physical form: mixture of powder and irregular particles up to 5 mm size.
PR CA = cellulose acetate, DS_{Ac} ˜2.4-2.5 (Primester Acetate Flake); Physical form: irregular particles ˜20 mm × 5 mm in size.
CA320S = cellulose acetate, DS_{Ac} ˜1.7 B 1.8 (Eastman Chemical Co.); Physical form: spherical about 2 mm diameter.

### Example 32

### Comparative Examples

Sample IA. Acetone-soluble, cellulose acetate (CA394-60, 50 g) was slurried into 1,000 g of water in a half-gallon jar and rolled in a heated cabinet at 60EC for 1 hour. To the slurry, 25 g dimethyl phthalate (DMP) and 5 g triphenyl phosphate (TPP) were added. The solid TPP (mp=48EC) melted and dispersed within several seconds once added to the hot mixture. The slurry continued to be stirred by rolling the jar at 60° C. for 5 additional hours. The solids were isolated by filtering using a fritted funnel with vacuum. The solids were dried on the funnel for 1 hour, then spread in a shallow pan to dry overnight at 25° C., and finally dried in a vacuum (about 25 mm Hg) oven at 50° C. for 24 hours. The decanted liquid had a slightly greasy feel. The weight of the dried cellulose acetate (theoretical maximum 80 g) is noted in Table 6.

Sample IB. Acetone soluble cellulose acetate (CA394-60, 50 g) was mixed in an 8-ounce jar containing a solution of 20 g methanol, 5 g ethyl acetate, 25 g dimethyl phthalate (DMP), and 5 g triphenyl phosphate (TPP). The jar was rolled on parallel motorized rollers to mix the contents for 5 hours at 25° C. The cellulose acetate particles had partially fused into a mass, but could be easily crumbled apart into granular swelled, softened particles. The granular solid was spread in a shallow pan to dry overnight at 25° C., then dried in a vacuum (about 25 mm Hg) oven at 50° C. for 24 hours. The weight of the dried cellulose acetate (theoretical maximum 80 g) is noted in Table 6.

Sample IC. Acetone soluble cellulose acetate (CA394-60, 50 g) was mixed in an 8-ounce jar containing a solution of 30 g methanol, 25 g dimethyl phthalate (DMP), and 5 g triphenyl phosphate (TPP). The jar was rolled on parallel motorized rollers to mix the contents for 5 hours at 25° C. At this time, all the liquids had been absorbed, and the cellulose acetate particles had partially fused, but could be easily crumbled apart to granular swelled, softened particles. The solids were spread in a shallow pan to dry at overnight at 25° C., then dried in a vacuum (about 25 mm Hg) oven at 50° C. for 24 hours. The weight of the dried cellulose acetate (theoretical maximum 80 g) is noted in Table 6.

Sample 2A. Acetone insoluble cellulose triacetate (CA436-80S, 50 g) was mixed into 1,000 g water in a half-gallon jar and rolled at room temperature for 1 hour, then rolled 30 minutes in a heated cabinet to bring the temperature up to 60EC. To the slurry, 10 g N-ethyl-p-toluenesulfonamide (ETS), 5 g dimethyl phthalate (DMP), 5 g triphenyl phosphate (TPP), and 0.3 g alizarin (CAS [72-48-0], Aldrich 33,317-4 tech grade 85%) were added. The slurry was rolled with heating (60° C.) for 8 hours. The solids were isolated by filtering using a fritted funnel with vacuum, dried on the funnel for 1 hour, spread in a shallow pan to dry overnight at 25° C., and finally dried in a vacuum (about 25 mm Hg) oven at 50° C. for 24 hours. The cellulose triacetate did not appear swelled, and had a mottled rust-yellow appearance. The decanted liquid had a slightly greasy feel. The weight of the dried cellulose acetate (theoretical maximum 70 g) is noted in Table 6.

Sample 2B. Acetone insoluble cellulose triacetate (CA436-80S, 50 g) was mixed into a solution of 40 g acetone, 10 g N-ethyl-p-toluenesulfonamide (ETS), 5 g dimethyl phthalate (DMP), 5 g triphenyl phosphate (TPP), and 0.3 g alizarin. The jar was rolled on parallel motorized rollers to mix the contents for 5 hours at 25° C. All of the liquids were absorbed to make swelled, rubbery pellets with a uniform rust color. The solids were spread in a shallow pan to dry overnight at 25° C., and then dried in a vacuum (about 25 mm Hg) oven at 50° C. for 24 hours. The weight of the dried cellulose acetate (theoretical maximum 70 g) is noted in Table 6.

Sample 3A. Acetone insoluble cellulose triacetate (CA436-80S, 50 g) was mixed into 1,000 g of water in a half-gallon jar and rolled at room temperature for 1 hour, then for 30 minutes in a heated cabinet to bring the temperature up to 60° C. To the slurry, 10 g N-ethyl-p-toluenesulfonamide (ETS), 5 g dimethyl phthalate (DMP), and 5 g triphenyl phosphate (TPP) were added. The slurry was rolled with heating (60° C.) for 8 hours. The solids were isolated by filtering using a fritted funnel with vacuum. The cellulose triacetate did not appear swelled, and the decanted liquid had a slightly greasy feel. The solids were dried on the funnel for 1 hour, then spread in a shallow pan to dry at 25° C. overnight, and finally dried in a vacuum (about 25 mm Hg) oven at 50° C. for 24 hours. The weight of the dried cellulose acetate (theoretical maximum 70 g) is noted in Table 6.

Sample 3B. Acetone insoluble cellulose triacetate (CA436-80S, 50 g) was mixed into a solution of 40 g acetone, 10 g N-ethyl-p-toluenesulfonamide (ETS), 5 g dimethyl phthalate (DMP), and 5 g triphenyl phosphate (TPP). The jar containing this mixture was rolled on parallel motorized rollers to mix the contents for 5 hours at 25° C. All of the liquids absorbed to give swelled, rubbery, dry-to-the-touch pellets. The weight of the dried cellulose acetate (theoretical maximum 70 g) is noted in Table 6.

For each comparative set, the sample using the water slurry showed only a small weight gain from incorporated plasticizer. The water method was more effective for the acetone soluble CA394-60 than for the cellulose triacetate, but both still fell short of their comparative counterparts that used a swelling agent matched to the cellulose acetate. The decanted water had a greasy feel, indicating the presence of plasticizer in the water phase. The water slurry method had the shortcoming of generating a large quantity of plasticizer-contaminated water to handle and recover. Furthermore, with plasticizer partitioned between the water phase and the cellulose acetate, achieving a target plasticizer level in the cellulose ester was difficult. Alternatively, by using a swelling agent in an amount that causes all of the liquids to be absorbed, the amount of plasticizer loading can be determined simply by the amount added. Using the swelling method, more plasticizer can be integrated into the cellulose acetate in the same or shorter contact time.

TABLE 6
Comparison of Water vs. Swelling Agent for Incorporating
Plasticizers into Cellulose Acetates

| | | | | | | | DRIED WEIGHT |
|---|---|---|---|---|---|---|---|
| | | | | | | | (% DMP) |
| | | | | | | MIXING | (% TPP) |
| | CA TYPE | ADDITIVES | | VEHICLE | | TIME/TEMP | (% ETS) |
| 1A | CA394-60S | 25 | g DMP | 1000 | g Water | 1 hr 60° C. | 72.6 g |
| | 50 g | 5 | g TPP | | | 5 hrs 60° C. | (25.3%) |
| | | | | | | | (5.4%) |
| | | | | | | | (—) |
| 1B | CA394-60S | 25 | g DMP | 20 | g Methanol | 5 hours 25° C. | 77.6 g |
| | 50 g | 5 | g TPP | 5 | g Ethyl acetate | | (29.0%) |
| | | | | | | | (5.5%) |
| | | | | | | | (—) |
| 1C | CA394-60S | 25 | g DMP | 30 | g Methanol | 3 hours 25° C. | 78.4 g |
| | 50 g | 5 | g TPP | | | | (29.0%) |
| | | | | | | | (5.5%) |
| | | | | | | | (—) |
| 2A | CA436-80S | 10 | g ETS | 1000 | g Water | 1 hr 60° C. | 52.8 g |
| | 50 g | 5 | DMP | | | 8 hrs 60° C. | |
| | | 5 | TPP | | | | |
| | | 0.3 | g alizarin | | | | |
| 2B | CA436-80S | 10 | g ETS | 25 | g Acetone | 4 hours 25° C. | 70.0 g |
| | 50 g | 5 | DMP | 5 | Methyl acetate | | |
| | | 5 | TPP | | | | |
| 3A | CA436-80S | 10 | g ETS | 1000 | g Water | 1 hr 25° C. | 52.3 g |
| | 50 g | 5 | DMP | | | 8 hrs 60° C. | (1.1%) |
| | | 5 | TPP | | | | (1.2%) |
| | | | | | | | (2.2%) |
| 3B | CA436-80S | 10 | g ETS | 40 | g Acetone | 5 hours 25° C. | 69.4 g |
| | 50 g | 5 | DMP | | | | (7.0%) |
| | | 5 | TPP | | | | (7.2%) |
| | | | | | | | (13.8%) |
| 3C | CA436-80S | 10 | g ETS | 25 | g Acetone | 4 hours 25° C. | 69.5 g |
| | 50 g | 5 | DMP | 5 | Methyl acetate | | (7.2%) |
| | | 5 | TPP | | | | (6.9%) |
| | | | | | | | (13.8%) |

CA436-80S = cellulose triacetate, DS_{Ac} ˜2.8-2.9 (Eastman Chemical Co.); Physical form: rice-like pellets.
CA394-60S = cellulose acetate, DS_{Ac} ˜2.4-2.5 (Eastman Chemical Co.); Physical form: mixture of powder and irregular particles up to 5 mm size.

### Example 33

### Comparative Examples

For samples 1A, 2A, and 3A, cellulose acetate (100 g of the type indicated in Table 7) was slurried in a gallon jar with 1,800 g water, 0.5 g Turkey red oil (sodium salt of sulfonated castor oil, which is a water-dispersible oil and surfactant obtained from Sigma Aldrich), and 0.5 g xylene. After rolling the jar for 1 hour at 25° C., 50 g dimethyl phthalate (DMP) and 10 g triphenyl phosphate (TPP) were added to the slurry, and the jar was moved to rollers in a heated cabinet to roll at 60EC for 60 minutes. The solids were separated from the slurry by filtration using a coarse, fritted funnel and vacuum. The solids were spread in a shallow pan to dry at 25° C. overnight (for about 16 hours) then in a vacuum oven at 50° C. for 24 hours.

For comparative samples 1B, 2B, and 3B, cellulose acetate (100 g of the type indicated in Table 7) was stirred into a 16-ounce jar (32-ounce jar for 1B) containing 50 g dimethyl phthalate (DMP) and 10 g triphenyl phosphate (TPP) dissolved in the swelling agent indicated in Table 7. The mixture was mixed by rolling on motorized parallel rollers at room temperature (25° C.) for 5 hours. By design there were no liquids to filter away from the solids. The solids were spread into a shallow pan to dry at 25° C. overnight for about 16 hours then dried in a vacuum oven at 50° C. for 24 hours.

For each comparative pair, the sample using the water/xylene/Turkey red oil mixture as the plasticizer carrier showed a negligible weight increase, and no plasticizer could be detected by additive analysis. By contrast, each comparative sample which used a swelling agent matched to the cellulose acetate and additive showed good swelling, good liquid incorporation, and a significant weight increase. This amount of plasticizer (60 g total) is relatively large for the 100 g quantity of cellulose acetate (typical plasticizer loading for cellulose acetate is 10-30%), but by using appropriate swelling agents for each type of cellulose acetate, near quantitative incorporation of the 60 grams of plasticizer could be realized. The combination of a plasticizer that has good compatibility with the cellulose acetate and a swelling agent that has the appropriate swelling action toward the cellulose acetate makes this high incorporation of plasticizer possible. The examples using water demonstrate that a compatible plasticizer alone is not sufficient to achieve good plasticizer uptake.

TABLE 7
Comparison of Water with Surfactant vs. Swelling Agent

| | | | | | | | DRIED WEIGHT |
|---|---|---|---|---|---|---|---|
| | | | | | | MIXING | (% DMP) |
| | CA TYPE | ADDITIVES | | VEHICLE | | TIME/TEMP | (% TPP) |
| 1A | CA398-30 | 50 | g DMP | 1800 | g water | 1 hr 60EC | 99.6 g |
| | 100 g | 10 | g TPP | 0.5 | g TRO | 5 hrs 60EC | (0.0%) |
| | | | | 0.5 | g xylene | | (0.0%) |
| 1B | CA398-30 | 50 | g DMP | 90 | g methanol | 5 hours 25EC | 155.5 g |
| | 100 g | 10 | g TPP | | | | (30.9%) |
| | | | | | | | (6.1)% |
| 2A | CA394-60S | 50 | g DMP | 1800 | g water | 1 hr 60EC | 100.3 g |
| | 100 g | 10 | g TPP | 0.5 | g TRO | 5 hrs 60EC | (0.0%) |
| | | | | 0.5 | g xylene | | (0.0%) |
| 2B | CA394-60S | 50 | g DMP | 60 | g methanol | 5 hours 25EC | 156.7 g |
| | 50 g | 10 | g TPP | | | | (31.3%) |
| | | | | | | | (6.3%) |
| 3A | CA436-80S | 50 | g DMP | 1800 | g water | 1 hr 60EC | 100.7 g |
| | 100 g | 10 | g TPP | 0.5 | g TRO | 5 hrs 60EC | (0.0%) |
| | | | | 0.5 | g xylene | | (0.0%) |
| 3B | CA436-80S | 50 | g DMP | 60 | g acetone | 5 hours 25EC | 158.1 g |
| | 100 g | 10 | g TPP | | | | (30.6%) |
| | | | | | | | (6.1%) |

CA398-30 = cellulose acetate, DS_{Ac} ˜2.4-2.5 (Eastman Chemical Co.); Physical form: powder.
CA394-60S = cellulose acetate, DS_{Ac} ˜2.4-2.5 (Eastman Chemical Co.); Physical form: mixture of powder and irregular particles up to 5 mm size.
CA436-80S = cellulose triacetate, DS_{Ac} ˜2.8-2.9 (Eastman Chemical Co.); Physical form: rice-like pellets.

### Example 34

### Melt Extruded Cellulose Triacetate Film

1. Melt Compounded Pellets/Melt Cast Film

Cellulose triacetate (CA436-80S) was melt compounded at 290° C. with triphenyl phosphate (TPP), diethyl phthalate (DEP), and an epoxy based thermal stabilizer to give compounded pellets comprising 80 parts cellulose triacetate, 15 parts TPP, 5 parts DEP, and 1 part stabilizer. Plasticizer analysis indicated 14.2% TPP and 4.8% DEP. The pellets were used as a feedstock for a melt cast film. The film was extruded on a 1-inch Killion film extruder with a 6-inch film die and a barrel set temperature of 280° C.

2. Nonthermally Compounded Pellets/Melt Cast Film

Cellulose triacetate (800 g, CA436-80S) was combined with a solution of 700 g acetone, 100 g methyl acetate, 150 g triphenyl phosphate (TPP), 50 g diethyl phthalate (DEP), and 10 g of an epoxy based thermal stabilizer. The mixture was rolled in a gallon jar overnight, after which a majority of the volatiles were removed by a rotary evaporation unit (Büchi Rotavapor RE121). Further drying at 85° C. overnight yielded compounded pellets comprising 80 parts cellulose triacetate, 15 parts TPP, 5 parts DEP, and 1 part stabilizer. Plasticizer analysis indicated 14.7% TPP and 5.1% DEP. The pellets were used as a feedstock for melt cast film. The film was extruded on a 1-inch Killion film extruder with a 6-inch film die and a barrel set temperature of 280° C.

The molecular weight was determined by gel permeation chromatography (GPC) in N-methylpyrrolidone (NMP) eluent vs. polystyrene standards. Values for the original cellulose triacetate, the two types of compounded pellets, and the melt cast film from each type of pellets were compared (Table 8). The difference in weight loss demonstrated the benefit of one less heat history that the nonthermal swelling compounding provides. Films of 5 mil thickness were solvent cast from the same samples. Percent transmission values for the films at 400 nm are listed in Table 8. The loss of transmission relative to the original cellulose triacetate demonstrates the color benefit of the swelling compounding over traditional melt compounding. The plasticizer infused cellulose triacetate could be a viable feedstock for a melt cast film, which would be useful for applications including packaging films, backings for adhesive tapes and sheets, membranes, and optical films.

TABLE 8
Molecular Weight Loss Comparison

| | | | | % Trans- |
|---|---|---|---|---|
| | | | | mission |
| SAMPLE | Mn | Mw | Mw/Mn | (400 nm) |
| CA436-80S starting material | 82,700 | 298,400 | 3.62 | 91.1 |
| Melt compounded pellets | 64,400 | 219,800 | 3.41 | 88.2 |
| Melt cast film (280EC) using | 56,100 | 195,400 | 3.52 | 85.2 |
| melt compounded pellets | | | | |
| “Swelling agent compounded” | 82,900 | 320,600 | 3.86 | 91.3 |
| pellets | | | | |
| Melt cast film (280EC) using | 66,300 | 246,200 | 3.71 | 87.8 |
| swelling agent compounded | | | | |
| pellets | | | | |

We claim:

1. A method of forming a compounded cellulose ester, said method comprising:
combining a cellulose ester, an initial quantity of an additive, and a swelling agent to yield an admixture; and
removing at least a portion of said swelling agent from said admixture so as to form a compounded cellulose ester, wherein said compounded cellulose ester comprises at least 92% by weight of said initial quantity of said additive.

2. The method of claim 1, wherein said cellulose ester comprises a C₁-C₂₀ ester of cellulose.

3. The method of claim 1, wherein said cellulose ester is selected from the group consisting of cellulose acetate, cellulose triacetate, cellulose acetate phthalate, cellulose acetate butyrate, cellulose butyrate, cellulose tributyrate, cellulose propionate, cellulose tripropionate, cellulose acetate propionate, carboxymethylcellulose acetate, carboxymethylcellulose acetate propionate, carboxymethylcellulose acetate butyrate, cellulose acetate butyrate succinate, and mixtures thereof.

4. The method of claim 1, wherein said additive is selected from the group consisting of plasticizers, thermal stabilizers, antioxidants, UV stabilizers, acid stabilizers, acid scavengers, dyes, pigments, fragrances, optical brighteners, flame retardants, agricultural chemicals, bioactive compounds, indicators, and mixtures thereof.

5. The method of claim 1, wherein said swelling agent is selected from the group consisting of ketones, esters, alcohols, ethers, carboxylic acids, tetrahydrofuran, supercritical fluids, and mixtures thereof.

6. The method of claim 5, wherein said swelling agent is selected from the group consisting of acetone, methyl ethyl ketone, ethyl acetate, methyl acetate, methanol, ethanol, isopropyl alcohol, acetic acid, supercritical carbon dioxide, and mixtures thereof.

7. The method of claim 1, said cellulose ester having an initial weight average molecular weight, and said compounded cellulose ester comprising a cellulose ester having a final weight average molecular weight, wherein said final weight average molecular weight is at least about 73% of the initial weight average molecular weight.

8. The method of claim 1, wherein a layer of said compounded cellulose ester having a thickness of about 5 mils has a percent transmittance of at least about 85% at light having a wavelength of about 400 nm.

9. The method of claim 1, wherein said removing step comprises removing at least about 95% by weight of said swelling agent.

10. The method of claim 1, further comprising forming said compounded cellulose ester into a shaped article.

11. The method of claim 10, wherein said shaped article is selected from the group consisting of films, fibers, time-release matrices, and indicator matrices.

12. The method of claim 11, wherein said shaped article comprises a film, and said forming comprises subjecting said compounded cellulose ester to melt processing to form the film.

13. The method of claim 12, wherein said melt processing comprises an extrusion process.

14. The method of claim 10, wherein said forming comprises subjecting said compounded cellulose ester to an injection molding process to form the shaped article.

15. A method of forming a compounded cellulose ester, said method comprising:
combining a cellulose ester, an initial quantity of an additive, and a swelling agent to yield an admixture, wherein said swelling agent comprises less than about 10% by weight of ingredients selected from the group consisting of water, benzene, sulfonated castor oil, benzene, xylene, toluene, monopol oil, pine oil, sulfonated pine oil, cyclohexanol, cyclohexanone, diacetin, and tetralin, said percentage by weight based upon the total weight of the swelling agent taken as 100% by weight; and
removing at least a portion of said swelling agent from said admixture so as to form a compounded cellulose ester.

16. The method of claim 15, wherein said cellulose ester comprises a C₁-C₂₀ ester of cellulose.

17. The method of claim 15, wherein said cellulose ester is selected from the group consisting of cellulose acetate, cellulose triacetate, cellulose acetate phthalate, cellulose acetate butyrate, cellulose butyrate, cellulose tributyrate, cellulose propionate, cellulose tripropionate, cellulose acetate propionate, carboxymethylcellulose acetate, carboxymethylcellulose acetate propionate, carboxymethylcellulose acetate butyrate, cellulose acetate butyrate succinate, and mixtures thereof.

18. The method of claim 15, wherein said additive is selected from the group consisting of plasticizers, thermal stabilizers, antioxidants, UV stabilizers, acid stabilizers, acid scavengers, dyes, pigments, fragrances, optical brighteners, flame retardants, agricultural chemicals, bioactive compounds, indicators, and mixtures thereof.

19. The method of claim 15, wherein said swelling agent is selected from the group consisting of ketones, esters, alcohols, ethers, carboxylic acids, tetrahydrofuran, supercritical fluids, and mixtures thereof.

20. The method of claim 19, wherein said swelling agent is selected from the group consisting of acetone, methyl ethyl ketone, ethyl acetate, methyl acetate, methanol, ethanol, isopropyl alcohol, acetic acid, supercritical carbon dioxide, and mixtures thereof.

21. The method of claim 15, said cellulose ester having an initial weight average molecular weight, and said compounded cellulose ester comprising a cellulose ester having a final weight average molecular weight, wherein said final weight average molecular weight is at least about 73% of the initial weight average molecular weight.

22. The method of claim 15, wherein a layer of said compounded cellulose ester having a thickness of about 5 mils has a percent transmittance of at least about 85% at light having a wavelength of about 400 nm.

23. The method of claim 15, wherein said removing step comprises removing at least about 90% by weight of said swelling agent.

24. The method of claim 15, further comprising forming said compounded cellulose ester into a shaped article.

25. The method of claim 24, wherein said shaped article is selected from the group consisting of films, fibers, time-release matrices, and indicator matrices.

26. The method of claim 25, wherein said shaped article comprises a film, and said forming comprises subjecting said compounded cellulose ester to melt processing to form the film.

27. The method of claim 26, wherein said melt processing comprises an extrusion process.

28. The method of claim 24, wherein said forming comprises subjecting said compounded cellulose ester to an injection molding process to form the shaped article.
